(19) United States
(12) Patent Application Publication
(10) Pub. No.: US 2023/0027493 A1
(43) Pub. Date: Jan. 26, 2023

(54) Modular Waveguide Displays and Related Applications

(71) Applicant: DigiLens Inc., Sunnyvale, CA (US)

(72) Inventors: Nima Shams, Sunnyvale, CA (US); Nicholas Sherwood, Sunnyvale, CA (US); George Hines, Sunnyvale, CA (US)

(73) Assignee: DigiLens Inc., Sunnyvale, CA (US)

(21) Appl. No.: 17/758,388

(22) PCT Filed: Dec. 31, 2020
(86) PCT No.: PCT/US20/67737

§ 371 Date: Jul. 5, 2022

Related U.S. Application Data
(60) Provisional application No. 63/063,155, filed on Aug. 7, 2020.
(60) Provisional application No. 63/030,256, filed on May 26, 2020.
(60) Provisional application No. 62/957,094, filed on Jan. 3, 2020.

(51) Int. Cl. G02B 27/01; F21V 8/00

(52) U.S. Cl. CPC G02B 27/0176; G02B 27/0172; G02B 6/0088; G02B 2027/0161; G02B 2027/0178; G02B 2027/0138; G02B 2027/015; H01M 50/247

(57) ABSTRACT

The present disclosure relates to modular waveguide displays including: a modular frame; a waveguide lens attached to the modular frame, where the waveguide lens in configured to be attached to the modular frame to locate one or more waveguides within the waveguide lens in front of the modular frame; and an optical engine which is configured to be attached to the modular frame, wherein, when the optical engine is attached to the modular frame, the optical engine is configured to provide image containing information to a front side of the one or more waveguides. Advantageously, a modular waveguide display allows for customization by a user. The modular waveguide display is designed to operate without such components as the optical engine when such functionality is undesired to save weight and power. Also, modular waveguide displays allow for parallel development of components such as the waveguide lens and the optical engine.

### CROSS-REFERENCED APPLICATIONS

This application claims priority to U.S. Provisional Application 62/957,094 filed on Jan. 3, 2020, U.S. Provisional Application 63/030,256 filed on May 26, 2020, and U.S. Provisional Application 63/063,155 filed on Aug. 7, 2020, the disclosures of which is included herein by reference in their entirety.

### FIELD OF THE INVENTION

The present invention generally relates to waveguide-based displays and, more specifically, to modular waveguide displays.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (“TIR”).

Fabrication of waveguides can include the use of material systems that allow for the recording of holographic optical elements within the waveguides. One class of such material includes polymer dispersed liquid crystal (“PDLC”) mixtures, which are mixtures containing photopolymerizable monomers and liquid crystals. A further subclass of such mixtures includes holographic polymer dispersed liquid crystal (“HPDLC”) mixtures. Holographic optical elements, such as volume phase gratings, can be recorded in such a liquid mixture by illuminating the material with two mutually coherent laser beams. During the recording process, the monomers polymerize, and the mixture undergoes a photopolymerization-induced phase separation, creating regions densely populated by liquid crystal micro-droplets, interspersed with regions of clear polymer. The alternating liquid crystal-rich and liquid crystal-depleted regions form the fringe planes of the grating. The resulting grating, which is commonly referred to as a switchable Bragg grating (SBG), has all the properties normally associated with volume or Bragg gratings but with much higher refractive index modulation ranges combined with the ability to electrically tune the grating over a continuous range of diffraction efficiency (the proportion of incident light diffracted into a desired direction). The latter can extend from non-diffracting (cleared) to diffracting with close to 100% efficiency.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for augmented reality (“AR”) and virtual reality (“VR”), compact head-up displays (“HUDs”) and helmet-mounted displays or head-mounted displays (HMDs) for road transport, aviation, and military applications, and sensors for biometric and laser radar (“LIDAR”) applications.

### SUMMARY OF THE DISCLOSURE

Many embodiments are directed to modular waveguide display devices, their design, and their methods of use.

Various embodiments are directed to a modular waveguide display device including:
a modular frame;
a waveguide lens attached to the modular frame, wherein the waveguide lens is configured to be attached to the modular frame to locate one or more waveguides within the waveguide lens in front of the modular frame; and
an optical engine which is configured to be attached to the modular frame, wherein, when the optical engine is attached to the frame, the optical engine is configured to provide image containing light to a front side of the one or more waveguides.

In various other embodiments, the front side of the one or more waveguides is the side opposite to a user's eye.

In still various other embodiments, the one or more waveguides include incoupling optical elements and outcoupling optical elements, and where, the optical engine is further configured to inject modulated light into the one or more waveguides through the incoupling optical elements.

In still various other embodiments, the outcoupling optical elements are configured to output the image containing light into a user's eye.

In still various other embodiments, the incoupling optical elements are configured to receive modulated light coming from the same direction as modulated light outputted by the outcoupling optical element.

In still various other embodiments, the modular frame includes at least one of one or more cameras, one or more speakers, one or more microphones, and one or more batteries.

In still various other embodiments, the one or more cameras includes stereo cameras integrated at opposite sides of the modular frame.

In still various other embodiments, the stereo cameras are configured to perform tracking.

In still various other embodiments, the tracking includes six degrees of freedom tracking.

In still various other embodiments, the one or more cameras includes a center camera mounted integrated in the center of the modular frame.

In still various other embodiments, the modular frame is adapted to accept another optical engine which is attachable to and removable from the waveguide lens, wherein, when the other optical engine is attached to the waveguide lens, the other optical engine is configured to inject light containing image information into the one or more waveguides.

In still various other embodiments, the optical engine is configured to be removable from the modular frame and the modular frame is capable of operating without the optical engine installed.

In still various other embodiments, the modular frame is configured to take images, take videos, operate as a virtual assistant, record sound, or play sound when the optical engine is removed.

In still various other embodiments, the waveguide lens is configured to be removable from the modular frame and the modular frame is capable of operating without the waveguide lens installed.

Further, various embodiments are directed to a modular waveguide display device including:
a waveguide lens;
an optical engine; and
a modular frame including:
   a first mechanical connector configured to connect the waveguide lens to the modular frame;
   a second mechanical connector configured to connect the optical engine to the modular frame; and
   an electrical connector which connects to a corresponding electrical connector on the optical engine allowing the modular frame to operate the optical engine,
wherein, when the waveguide lens and the optical engine are mounted on the modular frame, the optical engine is configured to inject light containing image data into the waveguide lens.

In various other embodiments, the optical engine is removable from the modular frame.

In still various other embodiments, the modular frame includes at least one of a mono-camera, a stereo-camera, audio speakers, or a microphone.

In still various other embodiments, the modular frame is configured to continue operating the at least one of mono-camera, stereo-camera, audio speakers, or microphone when the optical engine is removed from the modular frame.

In still various other embodiments, the modular frame includes a battery which is configured to power both the modular frame and the optical engine.

In still various other embodiments, the second mechanical connector and the electrical connector of the modular frame is configured to accept another optical engine.

In still various other embodiments, the optical engine and the other optical engine have different features from one another.

In still various other embodiments, the first mechanical connector is configured to accept another waveguide lens.

In still various other embodiments, the waveguide lens and the other waveguide lens have different features from one another.

In still various other embodiments, the waveguide lens includes incoupling optical elements and outcoupling optical elements.

In still various other embodiments, the incoupling optical elements are configured to incouple the light containing image data from the optical engine and the outcoupling optical elements are configured to outcouple the light containing image data into a user's eye.

In still various other embodiments, the optical engine is configured to inject light into the incoupling optical elements from a side of the waveguide lens opposite to the side where the outcoupling optical elements are configured to outcouple the light containing image data into the user's eye.

In still various other embodiments, the waveguide lens is configured to be substantially optically transparent to light from the surround environment.

Further, various embodiments are directed to a modular waveguide display device including:
a modular frame including:
   a first mechanical connector configured to connect a waveguide lens to the modular frame;
   a second mechanical connector configured to connect an optical engine to the modular frame; and
   an electrical connector configured to connect to a corresponding electrical connector on the optical engine allowing the modular frame to operate the optical engine,
wherein, when the waveguide lens and the optical engine are mounted on the modular frame, the optical engine is configured to inject light containing image data into the waveguide lens.

In various other embodiments, the optical engine is removable from the modular frame.

In still various other embodiments, the modular frame includes at least one of a mono-camera, a stereo-camera, audio speakers, or a microphone.

In still various other embodiments, the modular frame is configured to continue operating the at least one of mono-camera, stereo-camera, audio speakers, or microphone when the optical engine is removed from the modular frame.

In still various other embodiments, the modular frame includes a battery which is configured to power both the modular frame and the optical engine.

In still various other embodiments, the second mechanical connector and the electrical connector of the modular frame is configured to accept another optical engine.

In still various other embodiments, the optical engine and the other optical engine have different features from one another.

In still various other embodiments, the first mechanical connector is configured to accept another waveguide lens.

In still various other embodiments, the waveguide lens and the other waveguide lens have different features from one another.

In still various other embodiments, the waveguide lens includes incoupling optical elements and outcoupling optical elements.

In still various other embodiments, the incoupling optical elements are configured to incouple the light containing image data from the optical engine and the outcoupling optical elements are configured to outcouple the light containing image data into a user's eye.

In still various other embodiments, the optical engine is configured to inject light into the incoupling optical elements from a side of the waveguide lens opposite to the side where the outcoupling optical elements are configured to outcouple the light containing image data into the user's eye.

In still various other embodiments, the waveguide lens is configured to be substantially optically transparent to light from the surround environment.

### BRIEF DESCRIPTION OF THE DRAWINGS

The description will be more fully understood with reference to the following figures and data graphs, which are presented as exemplary embodiments of the invention and should not be construed as a complete recitation of the scope of the invention.

FIG. 1 conceptually illustrates a modular waveguide display implemented as eyeglasses in accordance with an embodiment of the invention.

FIG. 2 conceptually illustrates an exploded view of the modular waveguide display of FIG. 1.

FIGS. 3A and 3B are various view of the modular waveguide display of FIGS. 1 and 2.

FIG. 4 diagram illustrating the introduction of light to the front side of the waveguide in accordance with embodiments of the invention.

FIGS. 5A and 5B are various views of internal components of the optical engine in the modular waveguide display of FIGS. 1-3.

FIG. 6 is a cross-sectional view of an implementation of pins of a connector of the optical engine and pads on a connector of the modular frame in the modular waveguide display of FIGS. 1-3.

FIGS. 7A, 7B, and 7C are various view of the modular waveguide display of FIGS. 1-3 without the optical engine.

FIG. 8 is a perspective view of an example of the modular frame of the modular waveguide display of FIGS. 1-3.

FIGS. 9 and 10 are various views of the internals of the modular frame in accordance with an embodiment of the invention.

FIG. 11 is an exploded view of the modular waveguide display of FIGS. 1-3.

FIGS. 12A, 12B, and 12C are various implementations of the modular waveguide display of FIGS. 1-3 with various different waveguide lenses.

FIG. 12D is a comparison of the modular waveguide displays of FIGS. 12A, 12B, and 12C.

FIG. 13 is a comparison of various implementations of the modular waveguide display of FIGS. 1-3 with various different waveguide lenses.

FIG. 14 is a nose pad component according to an embodiment of the invention.

FIG. 15 is an exploded view of a modular waveguide display accordance to an embodiment of the invention.

FIG. 16A is an exploded view of a battery structure accordance to an embodiment of the invention.

FIG. 16B is a perspective view of the battery structure of FIG. 16A.

FIGS. 17A and 18B are various views of a waveguide lens accordance to an embodiments of the invention.

FIG. 18 is an exploded view of a modular frame of a modular waveguide display accordance to an embodiment of the invention.

FIG. 19A and 19B are various views of a modular waveguide display accordance to an embodiment of the invention.

FIG. 20 is an image of a modular waveguide display accordance with an embodiment of the invention.

FIG. 21 is a perspective of a modular waveguide display in accordance with an embodiment of the invention.

FIGS. 22A and 22B are various exploded views of the modular waveguide of FIG. 21.

FIGS. 23A-23C are various views of the modular waveguide display of FIG. 21 illustrating the presence of a retention wheel located on the optical engine.

FIG. 24 is a view of the modular waveguide display of FIG. 21 illustrating the presence of a nose clip mounted on the modular frame.

FIG. 25 is a perspective view of a housing which encapsulates the optical engine in accordance with an embodiment of the invention.

FIGS. 26A-26C are various views of the modular waveguide display of FIG. 21 illustrating the presence of an alignment ball in the optical engine in accordance with an embodiment of the invention.

FIG. 27 is a perspective view of the modular waveguide display of FIG. 21 without the optical engine installed in accordance with an embodiment of the invention.

FIG. 28A is an enlarged view of a slide clip mounted on the waveguide frame in accordance with an embodiment of the invention.

FIG. 28B is a cross-sectional view of the waveguide frame mounted on the modular frame in accordance with an embodiment of the invention.

FIGS. 29A and 29B are various views of the waveguide frame mounted on the modular frame in accordance with an embodiment of the invention.

FIGS. 30A and 30B are various views of the waveguide frame illustrating springs and a bracket in accordance with an embodiment of the invention.

### DETAILED DESCRIPTION

For the purposes of describing embodiments, some well-known features of optical technology known to those skilled in the art of optical design and visual displays have been omitted or simplified in order to not obscure the basic principles of the invention. Unless otherwise stated, the term “on-axis” in relation to a ray or a beam direction refers to propagation parallel to an axis normal to the surfaces of the optical components described in relation to the invention. In the following description the terms light, ray, beam, and direction may be used interchangeably and in association with each other to indicate the direction of propagation of electromagnetic radiation along rectilinear trajectories. The term light and illumination may be used in relation to the visible and infrared bands of the electromagnetic spectrum. Parts of the following description will be presented using terminology commonly employed by those skilled in the art of optical design. As used herein, the term grating may encompass a grating including a set of gratings in some embodiments. For illustrative purposes, it is to be understood that the drawings are not drawn to scale unless stated otherwise.

Waveguides and waveguide displays in accordance with various embodiments of the invention can be configured and implemented in many different ways. Conventionally, implementations of waveguide displays typically include bulky housing and components to accommodate various features. The components of these conventional waveguide displays are typically static and not easily changed. However, depending on the application, some features within the waveguide display may not be required or desired. This leads to unnecessary bulk that can affect the device's aesthetic and/or the user's comfort. As such, many embodiments of the invention are directed towards modular waveguide displays of which the solutions and implementations can keep bulk to a minimum for a specific application. A user is able to include only portions of the functionality which the user deems advantageous when the device is in use. Additionally, such designs can allow for the devices to be configurable by the end user to his or her aesthetic preference. Further, portions of the waveguide display may be changed based on a user's desires or based on new technology which may be released.

Further, modular waveguide displays have separate components which perform separate functions which are joined when the device is to be used. Having separate components allows for these separate components to be easily improved upon without having to adjust the entire display at any given time. This can speed up innovation within the given components which can decrease the ultimate cost and throughput of manufacture of the device. Also, the modularity of the display allows for separate components to be innovated upon by separate component manufacturers and then easily integrated into the overall device.

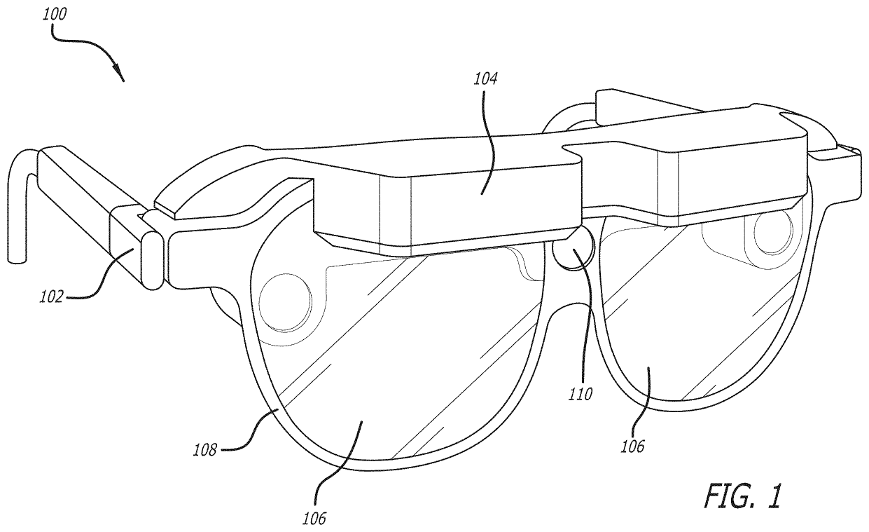

Referring now to the drawings, modular waveguide displays in accordance with various embodiments of the invention are illustrated. Modular waveguide displays can be implemented in many different devices, including but not limited to monocular and binocular eyewear. FIG. 1 is a perspective view of a modular waveguide display 100 implemented binocular eyewear (e.g. eyeglasses) in accordance with an embodiment of the invention. By implementing removable components, the display can be utilized for various applications while keeping bulk to a minimum. Eyeglass waveguide displays can be utilized for various applications, including but not limited to virtual reality, augmented reality, mixed reality, telepresence, and telecommunications. Eyeglass waveguide displays can also function as simple, traditional eyewear, which can include prescription and tinted lenses. In some embodiments, the waveguide display includes a removeable and/or swappable prescription insert. Device implemented for these applications, or a subset of these applications, can include removable components such that the end user can remove/include components for specific applications. Such components can also be swapped with other components for various purposes. The swappable components can allow for different choices in size, shape, material, and function. For example, the eyeglass waveguide displays may be capable of augmented reality. These eyeglass waveguide displays may include a light source or picture generation unit (e.g. a spatial light modulator).

With continued reference to FIG. 1, the modular waveguide display 100 includes a modular frame 102 with an optical engine 104 which is configured to be attached to the modular frame 102. The optical engine 104 is configured to be removable and swappable with other optical engines. The modular frame 102 may be operated without the optical engine 104 and still retain the functionality of the modular frame 102 with or without one or more waveguides 106. With the light source or optical engine 104 removed the user may utilize the device for telepresence applications without the use of AR or VR capabilities which may reduce the size of the device and/or enhance aesthetics. In addition to being removable, such devices can also allow for swappable optical engines, which can be advantageous as different applications can have different light and/or power requirements.

In a number of embodiments, the modular frame 102 may include a proximity sensor, which can allow for power saving operation. For example, the proximity sensor can determine whether a user is currently wearing the device. In cases where a user is not detected, the optical engine 104 may be turned off to conserve power. The modular frame 102 may include various features such as cameras, speakers, and microphones for various features and/or to enable other applications, such as but not limited to telepresence applications. These features may be included in the modular frame 102 or be provided through a series of attachments. The modular waveguide display 100 may further include one or more waveguides 106 which may be attached to the modular frame 102. When the optical engine 104 is attached to the modular frame 102, the optical engine 104 may be configured to inject light including image data into the one or more waveguides 106. The one or more waveguides 106 may be mounted in a waveguide frame 108. As illustrated, the optical engine 104 may be configured to inject light into the front of the one or more waveguides 106 in the same side as the environment and opposite to the viewer's eyes. The waveguide frame 108 may have a center camera cover 110 or a hole which may be adapted to fit with a center camera described below.

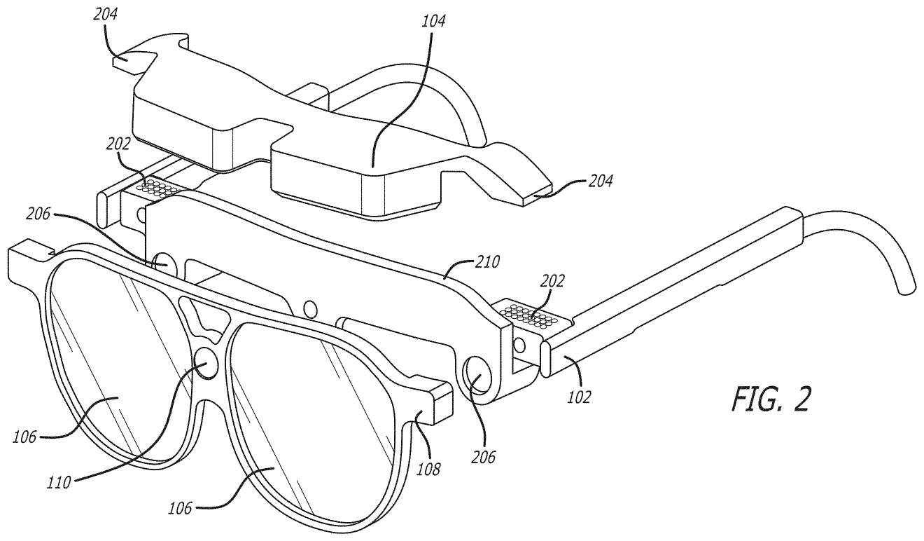

FIG. 2 illustrates an exploded view of the modular waveguide display 100 described in connection with FIG. 1. The description of FIG. 1 is applicable to FIG. 2 and will not be repeated. As shown, the optical engine 104 that can be coupled to the waveguide 106 through an attachment slot 210 on top of the modular frame 102. In some embodiments, the optical engine 104 latches onto the modular frame 102 to provide a flushed surface. Push spring release mechanisms can also be implemented for these latches. As can readily be appreciated, the modular waveguide display 100 can be designed to receive the optical engine 104 in different locations, the specific configuration of which can depend on the requirements of a given application. In many cases, the configuration of how the optical engine 104 is attached depends on the specific waveguide of the one or more waveguides 106 utilized.

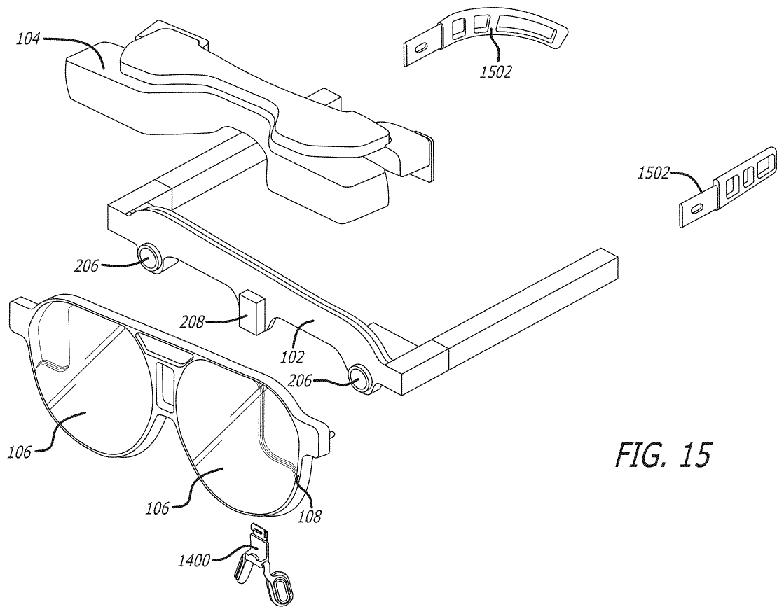

The modular frame 102 may include connectors 202 which may electrically communicate with a corresponding electrical connectors 204 included on the optical engine 104. The modular frame 102 may also include stereo cameras 206 mounted on opposite sides of the modular frame 102. The stereo cameras 206 may provide for tracking such as six degrees of freedom (6DoF) tracking. The modular frame 102 may also include a center camera 208 (seen in FIG. 15) which may be used to capture images and/or video for telepresence. The center camera 208 may be adapted for use with the center camera cover 110.

The modular waveguide display 100 in accordance with various embodiments of the invention can incorporate other removable and/or swappable components, including but not limited to electronics, cameras, microphones, power delivery components, batteries, fail-safe mechanisms, frames, and waveguides. In many embodiments, the modular waveguide display 100 includes an eyetracker. In some embodiments, the modular waveguide display 100 includes a wired connection point for data and power delivery. For example, in a number of embodiments, one of the temples include an interface point for a Universal Serial Bus (USB) connection, such as but not limited to USB-C. In several embodiments, one of the temples includes an antenna interface. For various reasons, including safety concerns, the display can be configured to have a wired connection severed in response to accidental tugging of the wired connection. In such cases, the modular waveguide display 100 may be adapted to still function despite the lost in power. In many embodiments, the modular waveguide display includes a battery component, which can be removeable/swappable to allow operation of the device without a wired power delivery mechanism. In several embodiments, at least one supercapacitor is implemented to power the modular waveguide display 100.

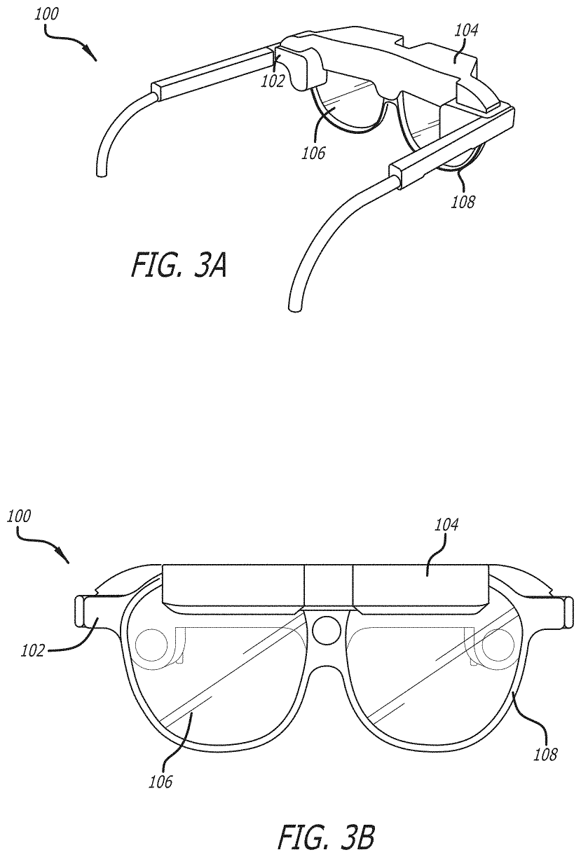

FIG. 3A is another perspective view of the modular waveguide display 100 described in connection with FIGS. 1 and 2. FIG. 3B is a front view of the modular waveguide display 100 described in connection with FIGS. 1 and 2. FIGS. 3A and 3B include identically numbered features to those of FIGS. 1 and 2. The description of identically numbered features are applicable to these figures and these descriptions will not be repeated.

Although FIGS. 1-3 illustrate a specific implementation of the modular waveguide display 100, various designs and configurations can be implemented as appropriate depending on the specific requirements of a given application. For example, different configurations can be implemented depending on the specific type of waveguide implemented. In some embodiments, the one or more waveguides 106 may include various waveguide technologies. The one or more waveguides 106 may include diffraction gratings for various functions such as input gratings (e.g. incoupling gratings), output gratings (e.g. outcoupling gratings), and/or beam expanders. These diffraction gratings may utilize Bragg gratings. Examples of waveguides incorporating Bragg gratings, waveguide display designs, and waveguide display configurations are discussed in the sections below in further detail.

### Waveguides Incorporating Bragg Gratings

Optical structures recorded in waveguides can include many different types of optical elements, such as but not limited to diffraction gratings. In many embodiments, the grating implemented is a Bragg grating (also referred to as a volume grating). Bragg gratings can have high efficiency with little light being diffracted into higher orders. The relative amount of light in the diffracted and zero order can be varied by controlling the refractive index modulation of the grating, a property that is can be used to make lossy waveguide gratings for extracting light over a large pupil. One class of gratings used in holographic waveguide devices is the Switchable Bragg Grating (“SBG”). SBGs can be fabricated by first placing a thin film of a mixture of photopolymerizable monomers and liquid crystal material between glass plates or substrates. In many cases, the glass plates are in a parallel configuration. One or both glass plates can support electrodes, typically transparent tin oxide films, for applying an electric field across the film. The grating structure in an SBG can be recorded in the liquid material (often referred to as the syrup) through photopolymerization-induced phase separation using interferential exposure with a spatially periodic intensity modulation. Factors such as but not limited to control of the irradiation intensity, component volume fractions of the materials in the mixture, and exposure temperature can determine the resulting grating morphology and performance. As can readily be appreciated, a wide variety of materials and mixtures can be used depending on the specific requirements of a given application.

In many embodiments, the SBGs may include holographic polymer dispersed liquid crystal (HPDLC) material. During the recording process, the monomers polymerize and the mixture undergoes a phase separation. The LC molecules aggregate to form discrete or coalesced droplets that are periodically distributed in polymer networks on the scale of optical wavelengths. The alternating liquid crystal-rich and liquid crystal-depleted regions form the fringe planes of the grating, which can produce Bragg diffraction with a strong optical polarization resulting from the orientation ordering of the LC molecules in the droplets.

The resulting volume phase grating can exhibit very high diffraction efficiency, which can be controlled by the magnitude of the electric field applied across the film. When an electric field is applied to the grating via transparent electrodes, the natural orientation of the LC droplets can change, causing the refractive index modulation of the fringes to lower and the hologram diffraction efficiency to drop to very low levels. Typically, the electrodes are configured such that the applied electric field will be perpendicular to the substrates. In a number of embodiments, the electrodes are fabricated from indium tin oxide (“ITO”). In the OFF state with no electric field applied, the extraordinary axis of the liquid crystals generally aligns normal to the fringes. The grating thus exhibits high refractive index modulation and high diffraction efficiency for P-polarized light. When an electric field is applied to the HPDLC, the grating switches to the ON state wherein the extraordinary axes of the liquid crystal molecules align parallel to the applied field and hence perpendicular to the substrate. In the ON state, the grating exhibits lower refractive index modulation and lower diffraction efficiency for both S- and P-polarized light. Thus, the grating region no longer diffracts light. Each grating region can be divided into a multiplicity of grating elements such as for example a pixel matrix according to the function of the HPDLC device. Typically, the electrode on one substrate surface is uniform and continuous, while electrodes on the opposing substrate surface are patterned in accordance to the multiplicity of selectively switchable grating elements.

Typically, the SBG elements are switched clear in 30 μs with a longer relaxation time to switch ON. Note that the diffraction efficiency of the device can be adjusted, by means of the applied voltage, over a continuous range. In many cases, the device exhibits near 100% efficiency with no voltage applied and essentially zero efficiency with a sufficiently high voltage applied. In certain types of HPDLC devices, magnetic fields can be used to control the LC orientation. In some HPDLC applications, phase separation of the LC material from the polymer can be accomplished to such a degree that no discernible droplet structure results. An SBG can also be used as a passive grating. In this mode, its chief benefit is a uniquely high refractive index modulation. SBGs can be used to provide transmission or reflection gratings for free space applications. SBGs can be implemented as waveguide devices in which the HPDLC forms either the waveguide core or an evanescently coupled layer in proximity to the waveguide. The glass plates used to form the HPDLC cell provide a total internal reflection (“TIR”) light guiding structure. Light can be coupled out of the SBG when the switchable grating diffracts the light at an angle beyond the TIR condition.

### Waveguides Incorporating Protective Layers

Waveguides and waveguide displays can include protective layers in accordance with various embodiments of the invention. In many embodiments, the waveguide or waveguide display incorporates at least one protective layer. In further embodiments, the waveguide or waveguide display incorporates two protective layers, with one on each side of the device. As discussed in the sections above, waveguides and waveguide displays can be constructed with transparent substrates that, through their air interfaces, provide a TIR light guiding structure. In those cases, the protective layer can be implemented and incorporated such that there is minimal disruption to the substrates' air interfaces. In some embodiments, the protective layer can by virtue of its material properties and/or method of deposition onto a waveguide substrate, compensate for surface defects in the substrate, such as not limited to a surface ripple, scratches, and other nonuniformities that cause the surface geometry to deviate from perfect planarity (or other desired surface geometries). Protective layers can be implemented in various thicknesses, geometries, and sizes. For example, thicker protective layers can be utilized for applications that require more durable waveguides. In many embodiments, the protective layer is sized and shaped similar to the waveguide in which it is incorporated. For curved waveguides, the protective layer can also be curved. In further embodiments, the protective layer is curved with a similar curvature as the waveguide. Protective layers in accordance with various embodiments of the invention can be made of various materials. As can readily be appreciated, the properties of the protective layer, including but not limited to thicknesses, shapes, and material compositions, can be selected based on the specific requirements of a given application. For example, protective layers can be implemented to provide structural support for various applications. In such cases, the protective layer can be made of a robust material, such as but not limited to plastics and other polymers. Depending on the application, the protective layer can also be made of glass, silica, soda lime glass, polymethyl methacrylate (PMMA), polystyrene, polyethylene, and other plastics/polymers.

In some embodiments, the protective layer can be incorporated using spacers to provide and maintain an air gap between the waveguide's substrates and the protective layers. Such spacers can be implemented similarly to those described in the sections above. For instance, a suspension of spacers and acetone can be used to spray onto the outer surface of the waveguide. In many cases, it is desirable to uniformly spray the suspension. The acetone can evaporate, leaving behind the spacers. The protective layer (which has had glue/adhesive/sealant/etc. added at the edges) can then be placed and vacuumed down into contact with the spacers. Although in some applications the spacers may move a small amount, they generally stay in place due to van der Waals forces. The spacers can be made of any of a variety of materials, including but not limited to plastics (e.g., divinylbenzene), silica, and conductive materials. In several embodiments, the material of the spacers is selected such that its refractive index does not substantially affect the propagation of light within the waveguide cell. The spacers can take any suitable geometry, including but not limited to rods and spheres. Additionally, spacers of any suitable size can be utilized. For instance, in many cases, the sizes of the spacers range from 1 to 30 μm. As can readily be appreciated, the shape and size of the spacers utilized can depend on the specific requirements of a given application. In some cases, the protective layer may advantageously be disposed further away from the waveguide. In such embodiments, larger sized spacers can be utilized.

The incorporation of protective layers can be implemented with different waveguide configurations, including single and multi-layered waveguides. For example, multi-layered waveguides can incorporate two protective layers, one disposed near each of the outer surfaces. In addition to providing environmental isolation and structural support for the waveguide, the protective layers can also be implemented for a variety of other applications. In many embodiments, the protective layer allows for dimming and/or darkening. The protective layer can incorporate materials for photochromic or thermochromic capabilities. The protective layer can also be configured to allow for controllable dimming and/or darkening. In several embodiments, the protective layer implements electrochromic capabilities. The protective layer can also provide a surface for other films, including but not limited to anti-reflective coatings and absorption filters. Such films can be implemented to avoid seeing light from the outside. In many cases, such films cannot be directly placed onto the waveguide, which can be due to the required high temperature processes or disturbance to the waveguiding in general. In many embodiments, the protective layer includes a coating that creates a mirroring effect. In some embodiments, the protective layer includes a gradual tint that is darker near the top of the lens. In a number of embodiments, the protective layer provides optical power. In further embodiments, the protective layer provides variable, tunable optical power. Such focus tunable lenses can be implemented using fluidic lenses or SBGs. In some applications, a picture generation unit is implemented and, depending on the waveguide application and design, may require an unobstructed light path between the PGU and the waveguide as the protective layer could refract the input beam, leading to positional errors. In many cases, an incident beam will contain rays that are at an angle to the waveguiding substrates. These effects will be exacerbated as the incident ray angles increase. Even for an incident beam that will not be refracted, there are still potential issues as the material used in the protective layer can impact the polarization of the beam and introduce scatter. In such embodiments, the protective layer can be designed and shaped accordingly to prevent the protective layer's interference with the light path.

### Modular Waveguide Displays

Modular waveguide displays in accordance with various embodiments of the invention can be configured in many different ways, including but not limited to incorporating different levels of modularity and the type and number of components to be implemented. In many embodiments, the choice of component and how such component is implemented can depend on the specific application and/or other components. For example, waveguides incorporating different gratings and grating designs can have different requirements of how and where the light from the optical engine is coupled. In a number of embodiments, the modular waveguide display is implemented as a monocular display, with only one lens being active and coupled to a projection system. The other lens may be a dummy lens or may include functionality such as correction of vision of the user.

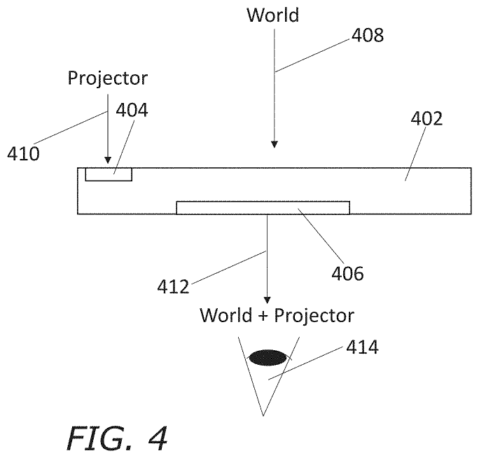

In some embodiments, the waveguide display is designed to have the optical engine introduce light to the front side of the waveguide (e.g. the side opposite the user's eyes). FIG. 4 is a diagram of a configuration where the optical engine includes a projector which introduces light to the front side of the waveguide in accordance with embodiments of the invention. Typically, in AR or VR devices, the projector is configured to introduce light from the rear side of the waveguide or the same side as the user's eyes. However, it has been discovered that introducing light from the rear side of the waveguide causes difficult alignment of the projector and the waveguides. Without limitation to any particular theory, introducing light from the rear side may cause portions of the waveguide (e.g. the incoupling optical elements and/or outcoupling optical elements) to act as mirrors which may cause difficult alignment of the projector light with the light outcoupled to the user's eye. Thus, it would be extremely beneficial when light is injected from the rear for precise alignment of the projector and the waveguide lens. However, precise alignment is difficult to implement in a modular waveguide display where the waveguide lens and the optical engine are frequently removed and swapped.

Conversely, implementing the projector on the front side of the waveguide or on the side opposite the user's eyes allows for easier alignment of the projector and the waveguide. Without limitation to any particular theory, introducing light from the front side may cause the waveguide to act as a periscope which allows a less precisely aligned projector and waveguide to function properly. Thus, implementing the projector on the front side of the waveguide allows for easy alignment of the waveguide lens and the optical engine which is beneficial for situation where the waveguide lens and the optical engine frequently removed and swapped which is the case in a modular design. FIG. 4 illustrates a waveguide 402 including an incoupling optical element 404 which incouples projector light 410. The projector light 410 comes from a direction on the same side of the waveguide 402 as the world light 408 and on an opposite side of the waveguide 402 as the user's eye 414. The waveguide 402 includes an outcoupling optical element 414 which outcouples light 412 including the projector light 410 and the world light 408 into the user's eye 414. The implementation described in connection with FIG. 4 may be implemented in the design described in connection with FIGS. 1-3.

Further, as can readily be appreciated, different types of optical engines 104 can be implemented as appropriate depending on the specific requirements of a given application. For example, the optical engine 104 may include projectors each including a waveguide integrated laser source. In other embodiments, an LED light source is utilized. As can readily be appreciated, various light sources and optical components, such as but not limited to prisms and collimating optics, can be utilized as appropriate depending on the specific requirements of a given application. The optical engine 104 may include projectors such as digital light processing (DLP) projectors, light-emitting diode (LED) projectors, liquid crystal display (LCD) projectors, or Liquid Crystal on Silicon (LCoS) projectors. The projectors may be one or more electrically switchable bragg grating (ESBG) devices which is disclosed in U.S. Pat. No. 8,224,133 entitled “LASER ILLUMINATION DEVICE” which is hereby incorporated by reference in its entirety. In some embodiments, the optical engine 104 can be implemented with two projectors in a single housing. Such configurations can ensure a set distance between the two projectors, which can be advantageous in many cases. In some embodiments, features are included to allow for the components to be implemented and attached to the device in a robust manner such that there are no alignment issues. In several embodiments, the components are designed to allow for a relatively high margin of misalignment. Specifically, in a number of embodiments, the waveguides are designed to still operate with a margin of misalignment to allow for robust incorporation into the device.

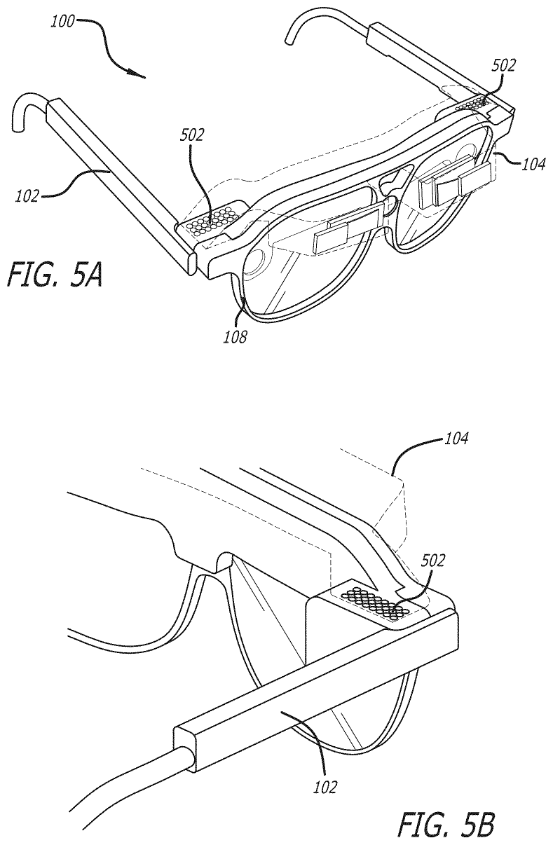

FIG. 5A conceptually illustrates the internal components of the optical engine 104 described in connection with FIGS. 1-3 in accordance with an embodiment of the invention. As illustrated, the optical engine 104 is electrically coupled to the modular waveguide display through two electrical connections 202 (e.g. MIPI interfaces) on either side of the eyewear frame. FIG. 5B shows an enlarged image of how the optical engine 104 is attached to one of the electrical connection 502. The optical engine 104 includes connectors 204 which correspond to the electrical connectors 202 of the modular frame 102 to make up the electrical connections 502. Connectors 204 of the optical engine 104 may include pins such as retractable pins. These retractable pins may be pogo pins. The pins may vary in length based on their different connection types in order to connect with the electrical connectors 202 of the modular frame 102 based on specific timings. The pins of the optical engine may correspond to pads of the electrical connectors 202 of the modular frame 102. As can readily be appreciated, various other connection interfaces can be utilized as appropriate, including connections for any signals and/or power delivery for other projection systems. The optical engine module 104 and the one or more waveguides 106 are all removable/swappable from the modular frame 102, which itself can be designed to be swappable for different modular frames 102. In some embodiments, the modular frame 102 may have more or less functionality depending on the desired functionality.

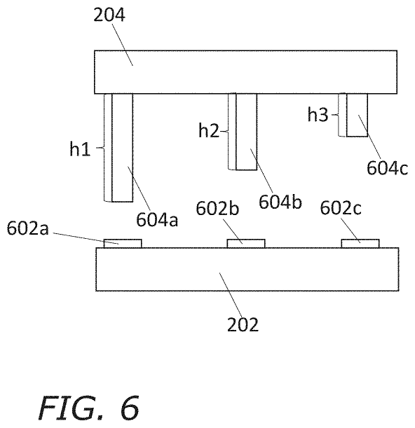

FIG. 6 is a cross sectional view of an example implementation of the pins 604a, 604b, 604c of the connector 204 of the optical engine 104 and their corresponding pads 602a, 602b, 602c of the electrical connector 202 of the modular frame 102. When the connector 204 of the optical engine 104 mates with an electrical connector 204 of the modular frame 102, the pins 604a, 604b, 604c connect in an order corresponding to their height. Thus, it is advantageous to have staggered heights when it is advantageous for certain components to connect before others. In this example, a first pin 604a has a first height h1, a second pin 604b has a second height h2, and a third pin 604c has a third height h3 and h1>h2>h3. Thus, when the connector 204 is joined to the electrical connector 202, the first pin 604a will connect to a first pad 602a of the electrical connector 204 followed by the second pin 604b to a second pad 602b of the electrical connector 204, and followed by the third pin 604c to a third pad 602c of the electrical connector 204.

In some embodiments, the first pin 604a may be connected to ground, the second pin 604b may be connected to signal, and the third pin 604c may be connected to power. Thus, when the connector 204 is joined to the electrical connector 202, the optical engine 104 is first connected to ground which purges the circuits within the optical engine 104 of any residual charge that may damage the circuits if the optical engine 104 was connected to power first. Next, the optical engine 104 is connected to signal which allows the device to be fully ready to operate before the optical engine 104 is connected to power. Lastly, the optical engine 104 is connected to power which powers the up the device only after the ground and signal have been connected. While, only one pin is shown for each of the first pin 604a, the second pin 604b, and the third pin 604c, one of ordinary skill would recognize that there could be multiple pins of similar height corresponding to each of these pins. Further, while only three different heights are included in this example, one of ordinary skill would understand that more heights may be included to allow for sequential connection of more components. In some embodiments, the connector 204 may be a MIPI connector to provide adequate data bandwidth while being a standardized connector. The connector 204 may also be other connector types to adjust for various aspects such as bandwidth requirements.

In many embodiments, the electrical connectors 202 of the modular frame 102 allow for a variety of different components to be electrically connected to the modular waveguide display 100. As discussed in the sections above, the modular waveguide display 100 can also operate with the optical engine 104 removed for reduced size and increased aesthetics. For example, if a user does not contemplate using the optical engine 104 functionalities during a particular session, then the modular waveguide display 100 may be run without the optical engine 104 while retaining the remaining functionality of the modular frame 102 and waveguides 106. The modular frame 102 may also be run by itself without the waveguides 106 to further save weight when the user does not desire the functionality of the waveguides 106.

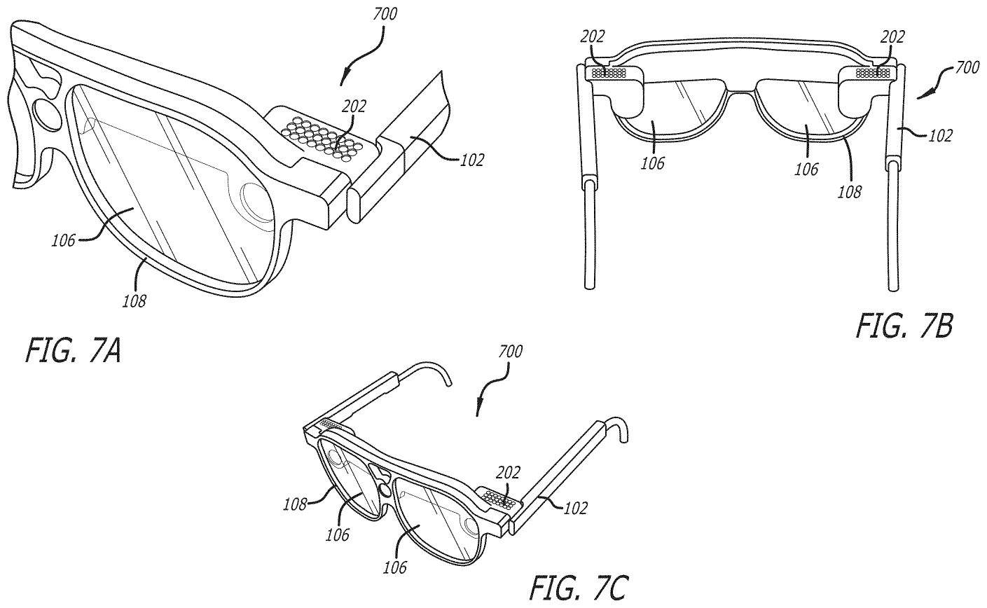

FIGS. 7A-7C conceptually illustrate three different views of a modular waveguide display 700 in accordance with an embodiment of the invention. The modular waveguide display 700 is the modular waveguide display 100 described in connection with FIGS. 1-3 except operated without the optical engine 104. The modular waveguide display 700 includes identically numbered features as those of the modular waveguide display 100 described in connection with FIGS. 1-3. The description of FIGS. 1-3 is applicable to FIGS. 7A-7C and these descriptions will not be repeated. The modular frame 102 includes electrical connectors 202 which are capable of accepting the optical engine 104. In some embodiments, the electrical connectors 202 allow for various components, such as but not limited to the optical engine 104, to be electrically connected to the eyewear device. In further embodiments, the electrical connectors 202 allow for the components to be electrically connected to internal electronics, such as but not limited to printed circuit boards, within the modular frame 102. However, the modular waveguide display 700 still provides functionality without the optical engine 104. For example, the modular frame 102 may include one or more cameras, speakers, and/or microphones which may be used to capture images, capture video, capture audio, and/or play audio. The modular frame 102 may be operated to provide a virtual assistant to the user. The cameras may integrate with the virtual assistant to provide audio feedback for video cues. The waveguides 106 may include optical correction capabilities which may be provided to the user even when the optical engine is absent. Removal of the optical engine 104 may decrease size, save weight, and conserve power.

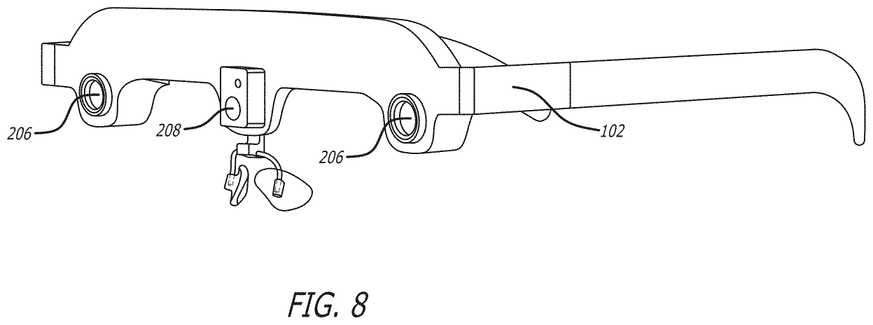

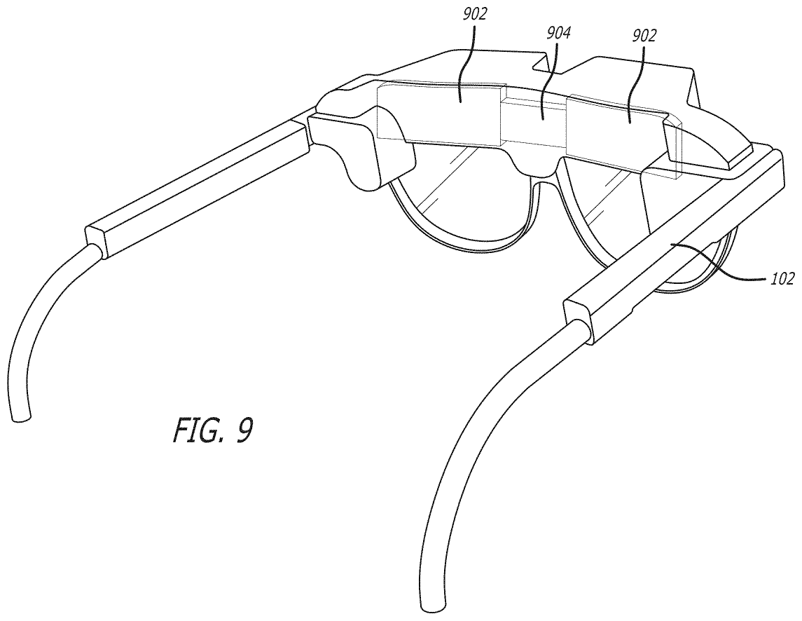

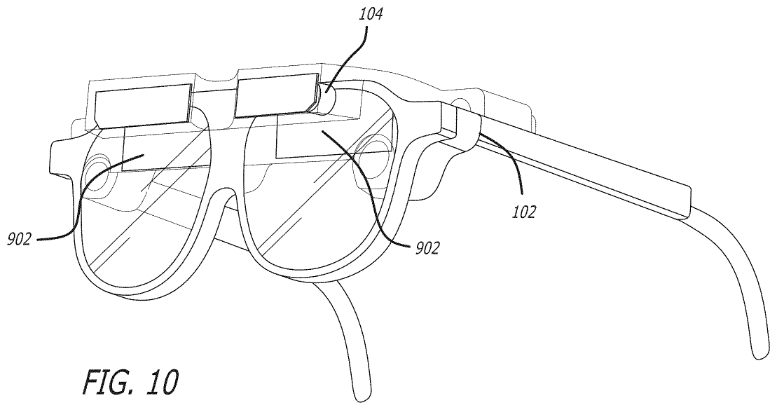

FIG. 8 conceptually illustrates a modular waveguide display 800 in accordance with an embodiment of the invention. As illustrated, the modular waveguide display 800 is the modular waveguide display 100 described in connection with FIGS. 1-3 operated without the optical engine 104 and the waveguides 106. The description of the modular frame 102 of FIGS. 1-3 is applicable in the modular waveguide display 700 of FIG. 8. Also, the description of the modular waveguide display 700 of FIG. 7 is applicable to FIG. 8. Removal of the optical engine 104 and the waveguides 106 may save weight and power. The modular frame 102 may be operated alone to provide the functionality described above without the optical engine 104 or the waveguides 106.

FIG. 9 conceptually illustrates an internal view of the modular frame 102 in accordance with an embodiment of the invention. As shown, the modular frame 102 houses two printed circuit boards 902 connected by a flex ribbon 904 in between. As can readily be appreciated, the electronics can be implemented as appropriated depending on the specific application. In many embodiments, the electronics provide instructions and processing power for the components with which they are connected. FIG. 10 conceptually illustrates an internal view of how the optical engine 104 is positioned with respect to the printed circuit boards 902 in accordance with an embodiment of the invention.

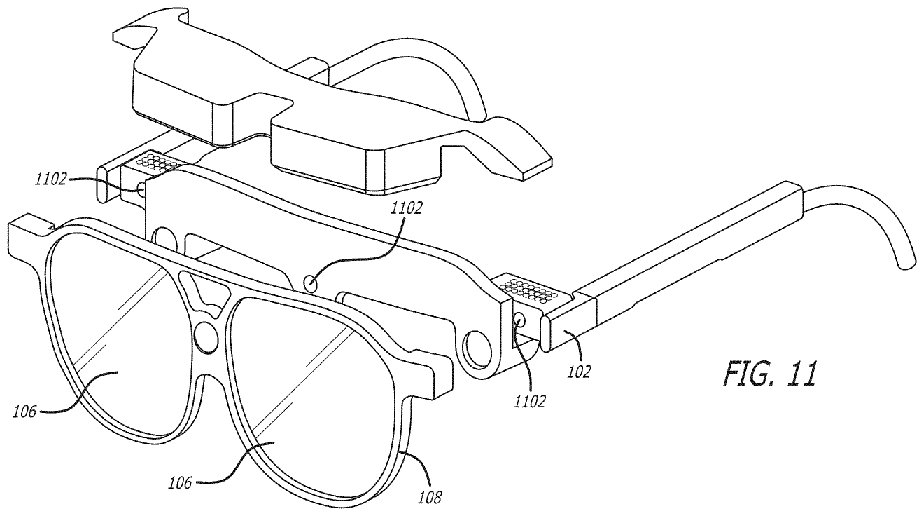

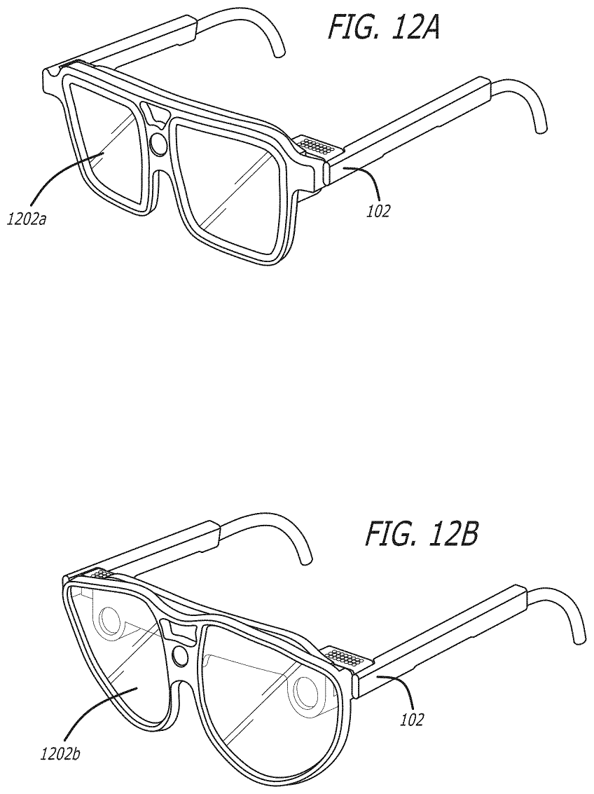

Modular components to be implemented with waveguide displays in accordance with various embodiments of the invention can be configured to be attached to the device in various ways. In many embodiments, the components are magnetically attached to the device. In some embodiments, the component is mechanically attached through latches or screws. FIG. 11 is an exploded view of the modular waveguide display 100 described in connection with FIGS. 1-3. The waveguide display 100 includes a modular frame 102, an optical engine 104, and one or more waveguides 106. As shown, the waveguides 106 may be housed in a waveguide frame 108 which may be attached to the modular frame 102 through several connection points 1102 dispersed through the front of the modular frame 102. The connection points 1102 may be magnetic and the waveguide frame 108 may have corresponding magnetic connections. In some embodiments, there may be three connection points 1102, two of which may be located at the sides of the front of the modular frame 102 and one of which may be located in the middle of the front of the modular frame 102. While connection points 1102 at the two sides of the front of the modular frame 102 may connect the modular frame 102 to the waveguide frame 108, it has been discovered that the third connection point 1102 in the center of front of the modular frame 102 creates more stability for the waveguides 106 which may be sensitive to movement. Further, there may be buttons on the side of the waveguide frame 108 which separate the waveguide frame 108 from the modular frame 102 and allow the waveguide frame 108 to be removed from the modular frame 102.

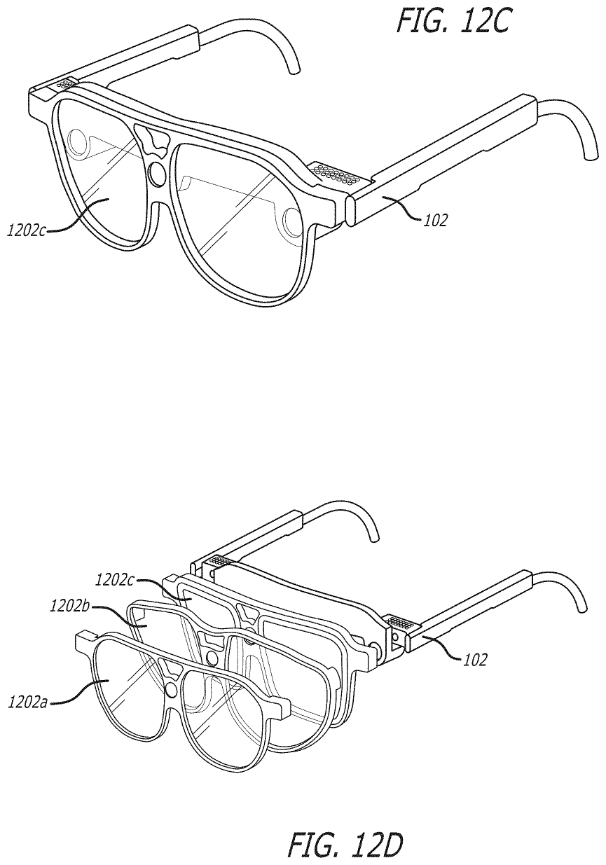

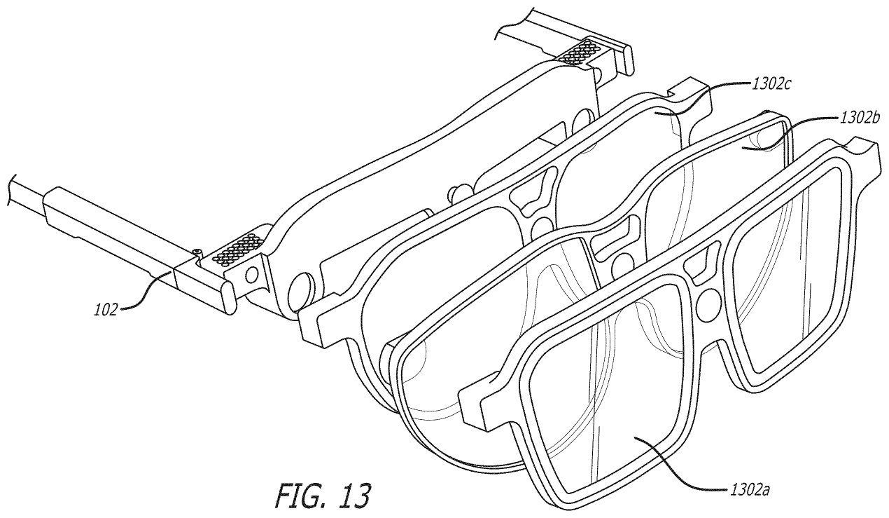

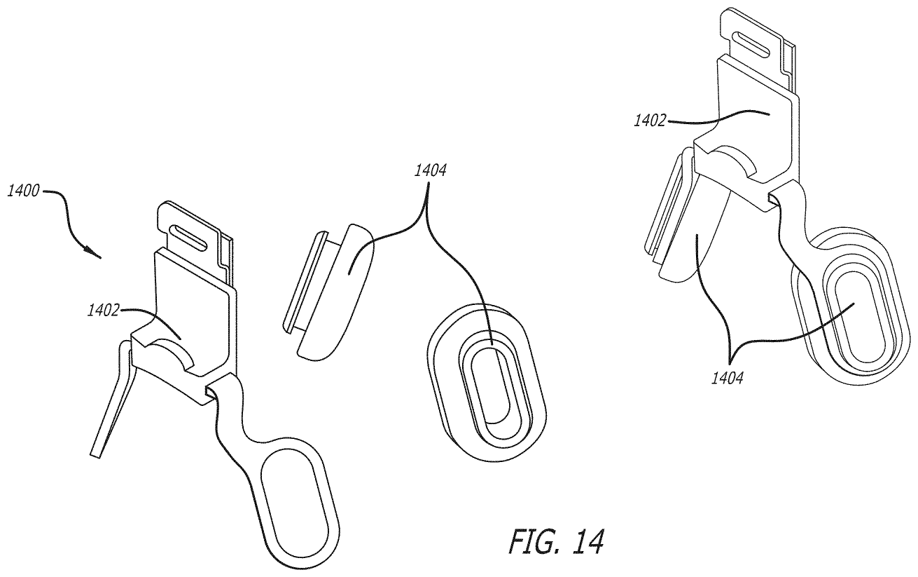

Modular components allow for the possibility of swappable modules that enable the end user to select and balance for aesthetic, comfort, and performance concerns. For example, waveguide modules can often be implemented in various shapes without altering the optical functions of the waveguide. As such, the waveguide modules can be implemented in various designs to allow for different aesthetical choices for the end user. FIGS. 12A-12C conceptually illustrate a modular frame 102 paired with a first waveguide module 1202a, a second waveguide module 1202b, and a third waveguide module 1202c in accordance with various embodiments of the invention. The waveguide modules 1202a, 1202b, 1202c each include one or more waveguides and a waveguide frame. The three different waveguide module designs may provide different aesthetic features and different functional features which may be selected based on a user's particular requirements. The user may also swap between the different waveguide modules 1202a, 1202b, 1202c based on a user's tastes, preferences, and utility for features at the time. FIG. 12D shows a comparison between the modular frame 102 paired with the first waveguide module 1202a, the second waveguide module 1202b, and the third waveguide module 1202c. FIG. 13 shows a comparison between the modular frame 102 paired with three additional waveguide modules 1302a, 1302b, 1302c.

In addition to providing flexibility in aesthetics and functionality, modular waveguide displays in accordance with various embodiments of the invention can provide a better fit for a wide variety of users. In many embodiments, the modular waveguide display includes various removeable and swappable components for customizing the fit for the user. For example, in some embodiments, the waveguide display includes swappable nose pads that varies in height, size, and/or shape. Such implementations can allow for a better fit across for users that may have nose features that deviates from the typical average. In several embodiments, the nose pad component is designed to mechanically attached to the modular waveguide display. In further embodiments, the nose pad components provide a further mechanical connection to a removeable nose pad frame. FIG. 14 illustrates a nose pad component 1400 in accordance with an embodiment of the invention. The nose pad component 1400 includes a removable nose pad frame 1402 which are adapted to mechanically connect to nose pads 1404. The nose pad frame 1402 may connect to any of the modular waveguide displays discussed through this disclosure. In some embodiments, the nose pad frame 1402 may connect to the modular frame 102. In some embodiments, the nose pad frame 1402 may connect to the waveguide frame 108. In many embodiments, the modular frame 102 is locked to the nose pad frame 1402 with a push spring releasing mechanism. As can readily be appreciated, such components can be implemented with different sizes and shapes to accommodate a wide range of the population.

Another customization option can include removable and/or swappable ear hooks. FIG. 15 is an exploded view of a modular waveguide display having removable ear hooks 1502 in accordance with an embodiment of the invention. FIG. 15 includes many identically labeled features as those of FIGS. 1-3. The description of FIGS. 1-3 are also applicable for FIG. 15. Also, FIG. 15 shows the nose pad component 1400 described in connection with FIG. 14. In FIG. 15, the modular waveguide display also includes removable ear hooks 1502. The removable ear hooks 1502 may connect into the modular frame 102 and hold the modular frame 102 on a user's face. Different ear hooks can swapped to provide a better fit depending on the user's head shape. In some embodiments, the removable ear hooks 1502 may be connected with a strap or band. Such components can be advantageous for various applications, including but not limited to athletics.

Depending on the application, weight distribution of the modular waveguide display can be a concern. For example, in some applications, the modular waveguide display is front-heavy. In such cases, it can be advantageous for the temples of the modular frame 102 to provide a greater hold on the user's head. As such, the modular frame 102 may include temple components with movable joints having a preload. In a number of embodiments, the temples are weighted to counteract the weight of any front components, providing adequate weight distribution for a more comfortable fit. In some embodiments, the temple can open wider than 90 degrees relative to the waveguide lens 106 and waveguide frame 108. Such implementations can also allow for compatibility with larger head sizes.

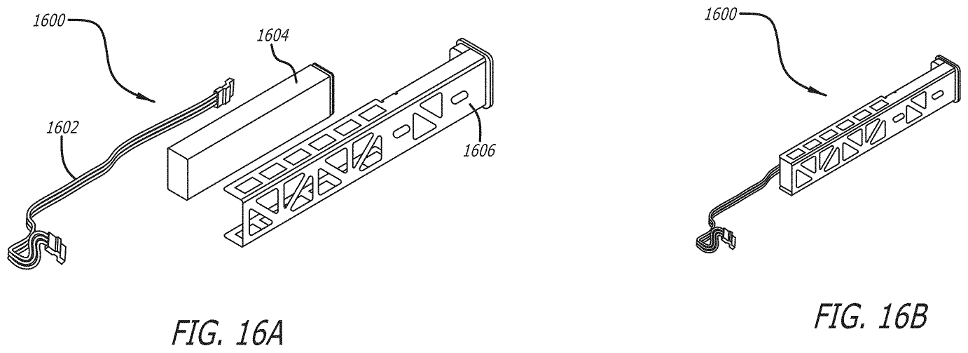

In addition to customized fit, many modular waveguide displays are designed with various safety features. For example, as discussed above, such modular waveguide displays can include one or more batteries for providing power, or uninterrupted power as a secondary backup power source. In such embodiments, the battery(s) can be incorporated within one or both of the temple component of the modular frame 102. FIG. 16A is an exploded view of a battery structure 1600 including a battery 1604 and an internal frame structure 1606 which can make up the temple component of the modular frame 102 in accordance with an embodiment of the invention. FIG. 16B is a perspective view of the battery structure 1600 of FIG. 16A. As shown, the internal frame structure 1606 can house the battery 1604 while only covering one side of the battery 1604. This asymmetrical covering allows for a weaker point for any force to preferentially escape. By positioning the weaker side away from the user's head, such hazards can be mitigated. However, typical battery components introduce safety concerns, including but not limited to the possibilities of battery failure resulting in the battery catching on fire or exploding. Since the temple components are in proximity to the user's head, this is a critical concern. In many embodiments, the construction of the temple components and internal structures of such components are designed to mitigate potential hazards including those described above. For example, an internal frame structure 1606 can be provided that strengthens only the side closest to the user's head. In case of any exothermic force, the energy will be directed towards the weaker side—e.g., the side away from the user's head that is not reinforced. In several embodiments, the temple component can be constructed to be thicker on the side closer to the head for the same reasons as the implementation of the internal structure described above. As can readily be appreciated, both methods can be implemented together. The battery structure 1600 also includes a wiring 1602 which is used to connect the battery 1604 to the circuit boards within the modular frame 102. While the wiring 1602 is illustrated on the side away from the head, the wiring 1602 may also be positioned to run along the other side.

With reference back to FIGS. 1-3, another safety consideration includes the nature of the waveguides 106 within the modular waveguide display 100. As described above, waveguides 106 in accordance with various embodiments of the invention can be implemented using glass substrates. In many cases, these substrates are thin and can be prone to shattering. Given that these waveguides are meant to be operated near the user's eyes, there is a potential hazard if the waveguides 106 were to shatter into shards. To address this issue, the waveguides 106 can include at least one additional layer of material on the side facing the user's eyes. This layer can be applied similarly to the protective layer as described above. In many embodiments, the additional layer includes an anti-reflective coating. In some embodiments, the additional layer is made of a robust material, such as but not limited to plastics, polymers, shatter-resistant glass, and glass substrates backed by a film.

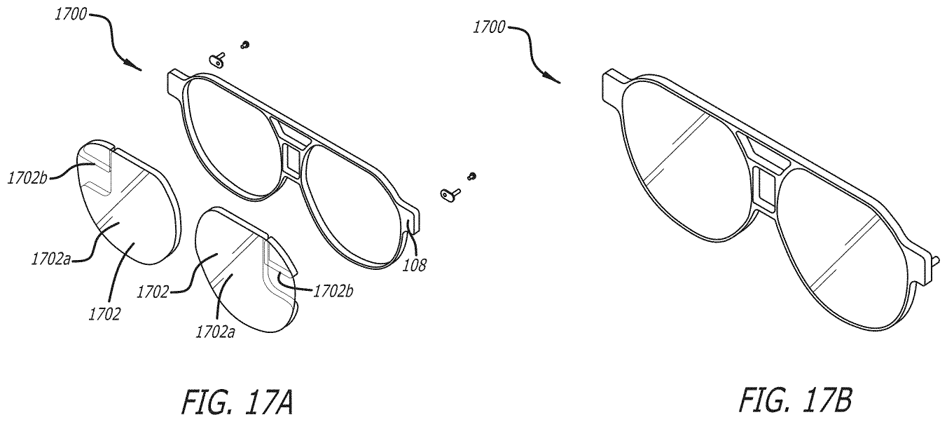

Turning back to FIG. 15, in many embodiments, the waveguide display includes at least one tracking camera 206. In further embodiments, the waveguide display includes two tracking cameras 206, positioned on either side of the user's head. In some applications, it is advantageous for the camera to be placed as forward as possible, with respect to the user's perspective, to allow for enough clearance such that there is no interference from any of the modular waveguide display's components to the operation of the camera 206. To accommodate this, many embodiments include waveguides 106 shaped to allow the camera 206 to be placed in the same plane as the waveguide 106. FIG. 17A is an exploded view of one example of a waveguide lens 1700 which includes waveguides 1702 held together by a waveguide frame 108. FIG. 17B is an integrated view of the waveguide lens 1700 described in connection with FIG. 17A. As shown, the waveguides 1702 are shaped to allow a camera to be placed as far forward as possible. The waveguides 1702 include a waveguide portion 1702a and a camera portion 1702b. In the illustrative embodiment, the waveguides 1702 includes a protective layer that covers both the waveguide portion 1702a and the camera portion 1702b.

The tracking cameras 206 can be implemented in many different ways. In a number of embodiments, the cameras 206 are each coupled together with a speaker to form a module. In many implementations, the camera 206 forms a pocket of air behind the lens. By coupling the camera 206 together with a speaker, the pocket can be utilized as an internal resonance cavity for the speaker. Such configurations can allow for smaller footprints compared to traditional implementations. In some embodiments, the modular frame 102 includes two camera/speaker modules, each positioned near a corner at which a temple connects to a main frame body. Due to the round shape of a typical user's head and the angular corners formed by the main frame body and the temples, there exist spaces in which the modules can be disposed without affecting the fit of the modular waveguide display 100. By positioning the cameras 206 on either side of the user's head, the required distance for some applications, such as but not limited to depth perception, can be satisfied. Additionally, similarly placement for the cameras 206 can allow for stereo sound. In further embodiments, the waveguide display further includes an additional set of speakers disposed within the temples.

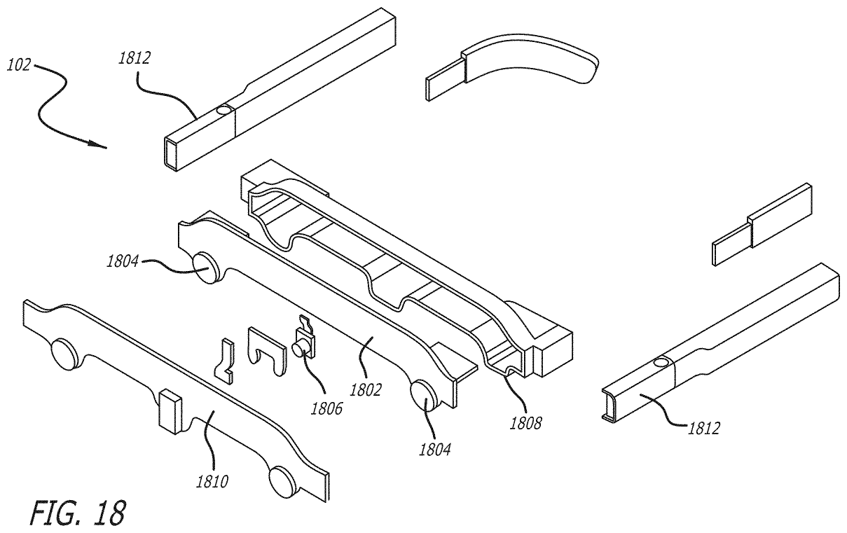

FIG. 18 is an exploded view of a modular frame 102 in accordance with an embodiment of the invention. As illustrated, the modular frame 102 includes a circuit board 1802 which includes stereo camera modules 1804. The circuit board 1802 may also include a center camera module 1806. The circuit board 1802 may be housed within a front module housing 1808. A front plate 1810 encapsulates the circuit board 1802 within the front module housing 1808. The front module housing 1808 connects to two temples 1812. The various components and electronics of the modular waveguide display 100 may generate a large amount of heat. For example, the circuit board 1802 may support various electrical or electronic components, such as but not limited to a central processor. In a number of embodiments, the circuit board 1802 and processor is incorporated in the front module housing 1808, which is disposed near the user's forehead when the modular waveguide display 100 is worn. As such, heat production can be an issue in relation to the user's comfort. In many embodiments, the front plate 1810 may act as a heatsink disposed on the side opposite the user's head and designed to be thermally connected with at least one of the electronic components, such as but not limited to the central processor, in order to facilitate the dissipation of heat.

In addition to the passive usage of heatsinks, the modular waveguide display 100 can include perforations in the modular frame 102 or a housing of the optical engine 104. The perforations can allow for better air flow, which increases the dissipation of thermal energy due to the circulation of the ambient air. In some embodiments, perforations are placed to allow external air to flow inside the housing of the optical engine 104 and over one or more heat generating component, such as the central processor. This airflow path can allow for heightened cooling when the user is currently in motion, which can force more airflow over the heat generating component. In several embodiments, performance of the components can be controlled, or throttled, depending on the current operating condition. For example, the modular waveguide display 100 can be configured to determine, using sensors such as but not limited to inertial measurement unit sensors, whether a user is in motion and how much motion in order to throttle the performance of any electronic component as necessary (e.g. the faster the user is in motion, the more airflow and cooling is provided to the components, allowing for higher levels of performance).

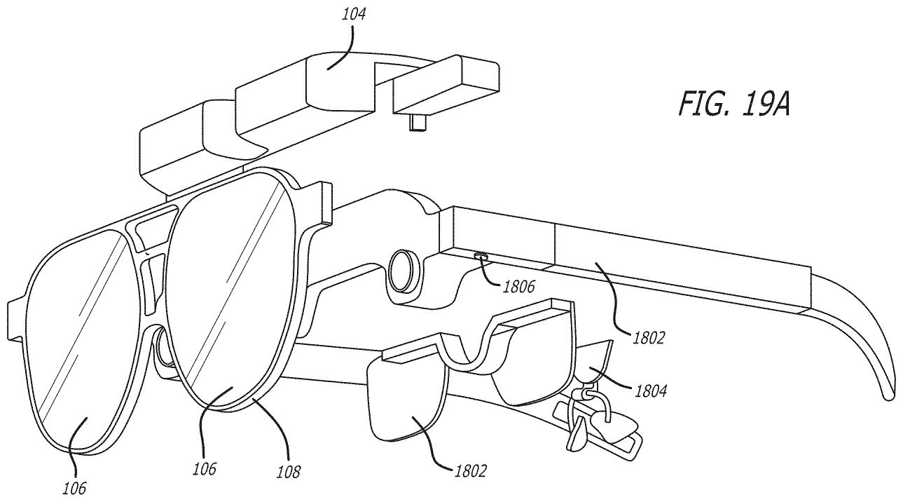

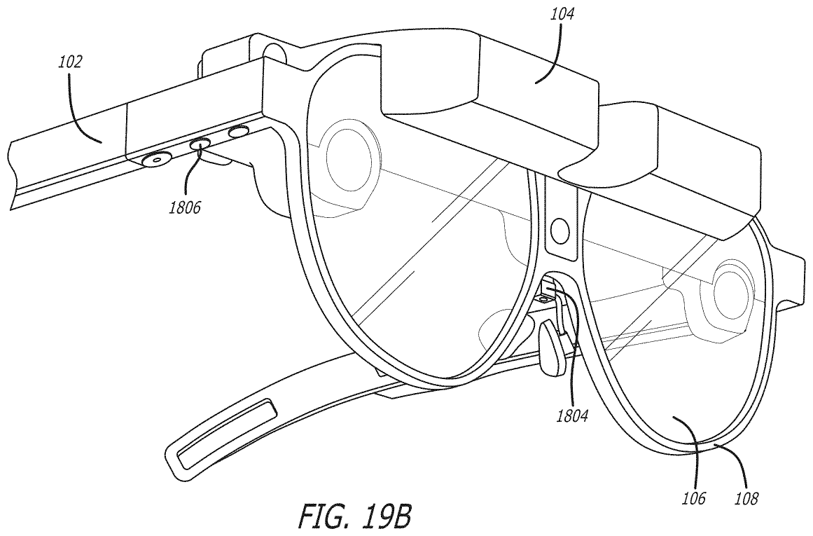

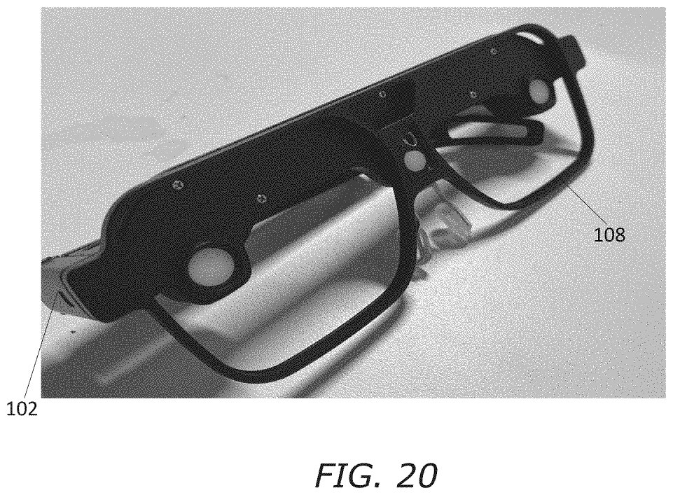

FIG. 19A illustrates an exploded view of an implementation of a modular waveguide display according to an embodiment of the invention. FIG. 19B is a perspective view of the modular waveguide display of FIG. 19A. The modular waveguide display of FIGS. 19A and 19B share identically numbered features as the modular waveguide display 100 of FIGS. 1-3 and these features will not be repeated. The modular waveguide display may include a prescription lens 1902 which is configured to provide vision correction to the user. The prescription lens 1902 may be mounted with nose pads 1904. The prescription lens 1902 mounted behind the waveguides 106. The modular frame 102 may also include one or more buttons 1906 which allow the user to control the modular waveguide display. FIG. 20 illustrates an image of an example waveguide frame 108 mounted on a fabricated modular frame 102.

### Additional Features

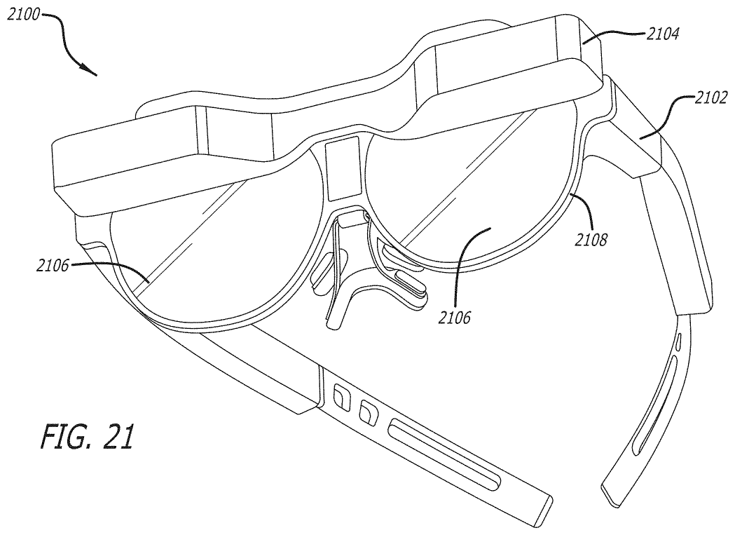

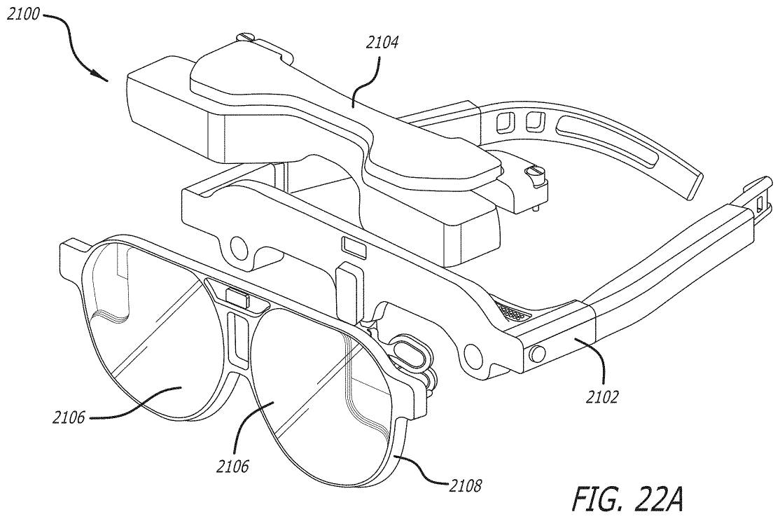

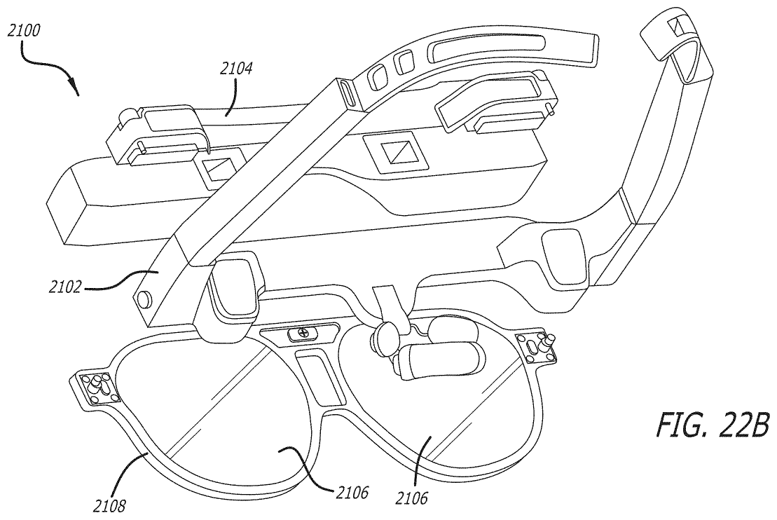

FIGS. 21-30 illustrates an example embodiment including various additional features which may be present in any of the embodiments discussed above. FIG. 21 is a perspective view of a modular waveguide display 2100 in accordance with an embodiment of the invention. FIGS. 22A and 22B are various exploded views of the modular waveguide display 2100. The modular waveguide display 2100 includes a modular frame 2102. The modular frame 2102 may be attached to an optical engine 2104 and one or more waveguides 2106. The optical engine 2104 may be adapted to input light including image data into the one or more waveguides 2106. The one or more waveguides 2106 may be mounted on a waveguide frame 2108.

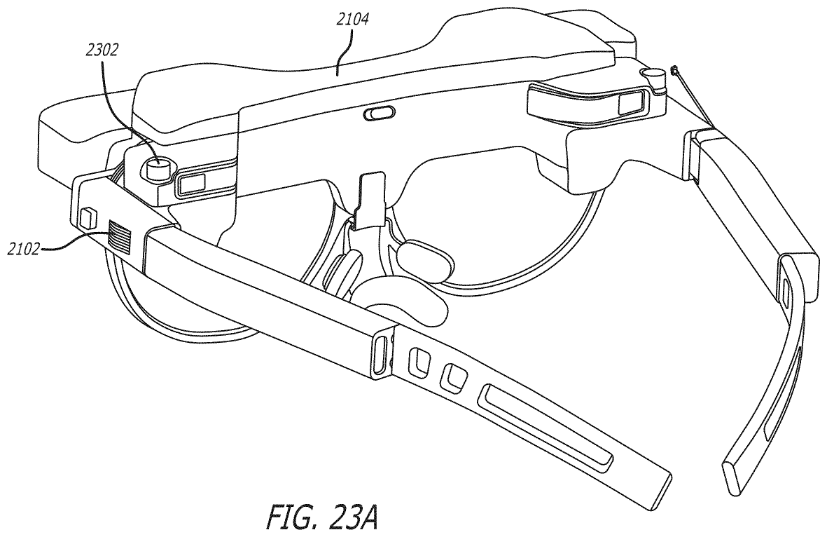

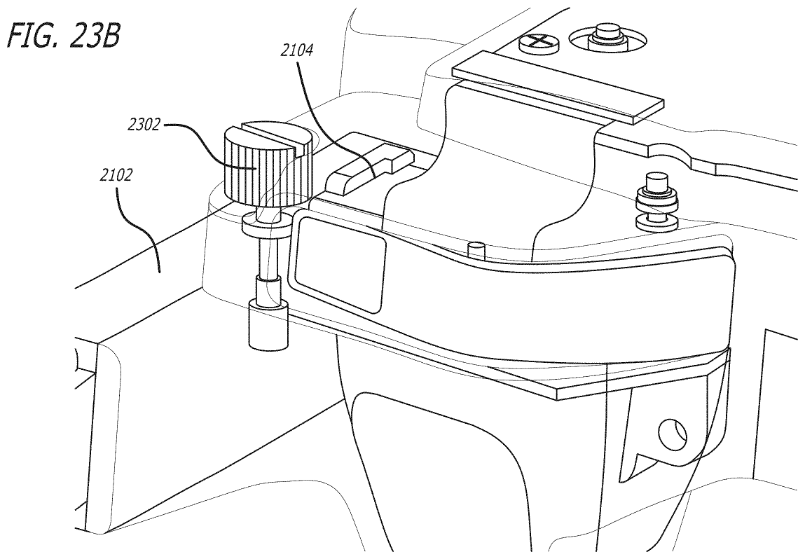

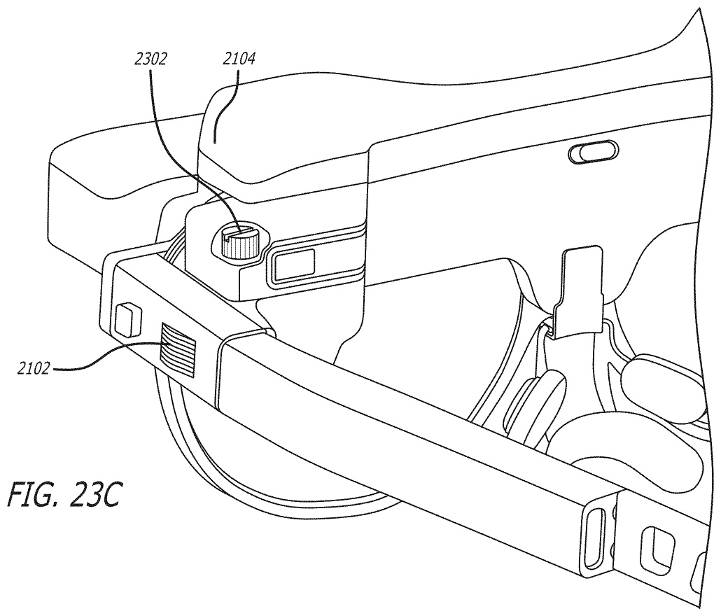

FIGS. 23A-23C are various views of the modular waveguide display 2100 illustrating the presence of a retention wheel 2302 located on the optical engine 2104. The retention wheel 2302 may be used to adjust the amount of tension of the which may be applied to from the optical engine 2104 onto the modular frame 2102. Tension from the optical engine 2104 may produce flexion in the modular frame 2102 which may flex the waveguide frame 2108 which thus flexes the one or more waveguides 2106. Optimizing the amount of tension placed on the modular frame 2102 may limit the amount of flex within the one or more waveguides 2106 which may be extremely sensitive to the amount of warpage. The retention wheel 2302 may be adjusted through a user's thumb or other fingers.

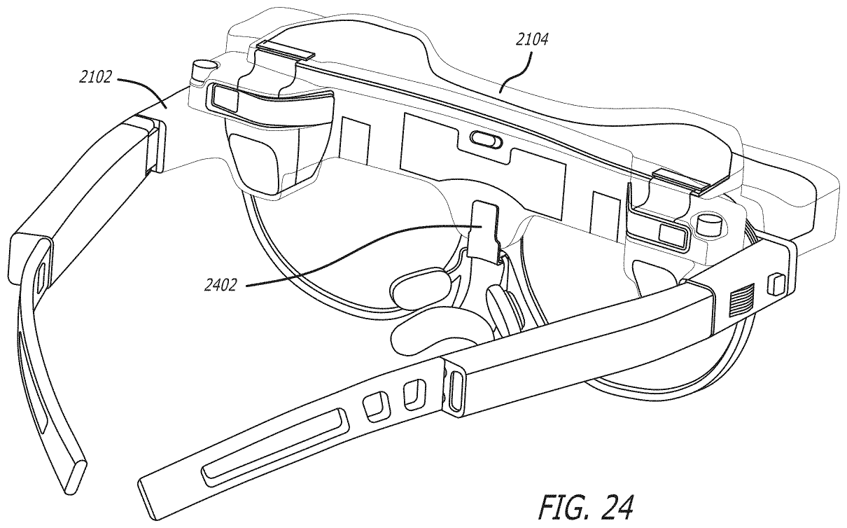

FIG. 24 is a view of the modular waveguide display 2100 illustrating the presence of a nose clip 2402 mounted on the modular frame 2102. When a user wears the modular waveguide display 2100 the nose clip 2402 contacts the nose. As illustrated, the nose clip includes multiple places of contact at multiple locations of the nose which may improve balance of the modular waveguide display 2100 on the user's nose. While weight is minimized in the modular waveguide display 2100, this device tends to be heavier than traditional eyeglasses and thus the updated nose clip 2402 allows the user's nose to properly balance the additional weight.

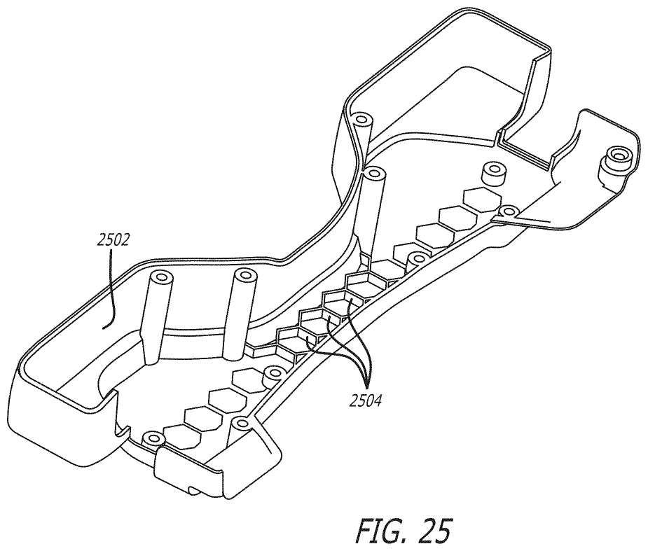

FIG. 25 is a perspective view of a housing 2502 which encapsulates the optical engine 2104 in accordance with an embodiment of the invention. The housing 2502 may protect the internal components of the optical engine 2104 such as the projectors. The housing 2502 may include ribs 2504 placed in the interior portion of the housing 2502. The ribs 2504 may improve the strength of the housing 2502 which allow the housing 2502 to better protect the optical engine.

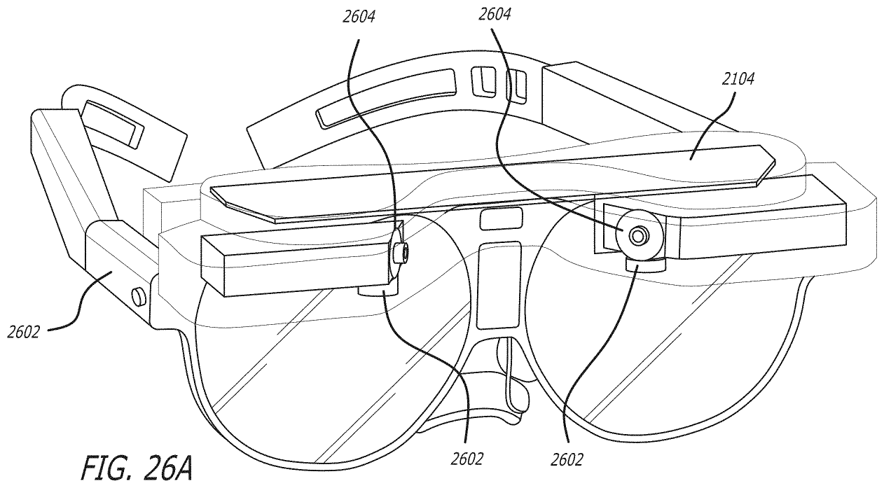

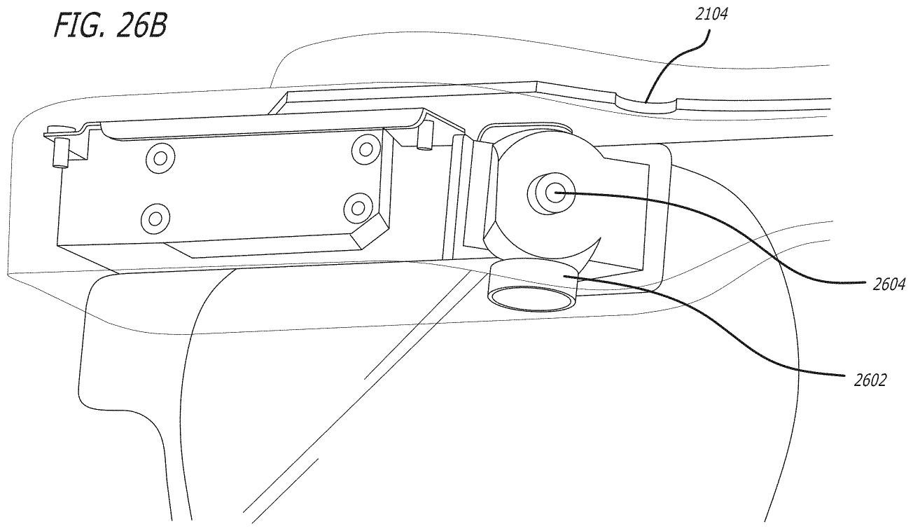

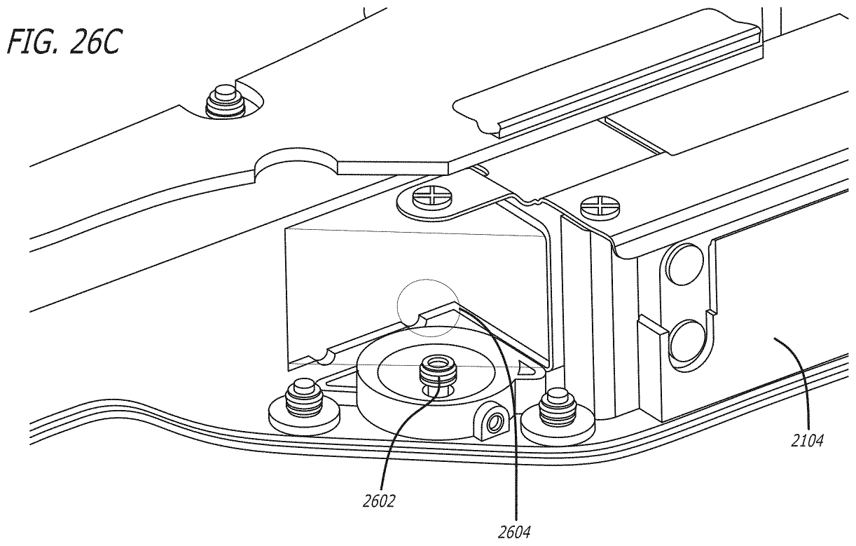

FIGS. 26A-26C are various views of the modular waveguide display 2100 illustrating the presence of an alignment ball 2602 in the optical engine 2104. The alignment ball 2602 may be used to align components 2604 of projectors. During operation, the components 2604 of the projector affect various properties (e.g. directionality) of the light transmitted into the one or more waveguides 2606. The alignment ball 2602 may be used to align the light transmitted into the one or more waveguides 2606. Because of the modularity of the modular waveguide display 2100, the alignment of the optical engine 2104 and one or more waveguides 2606 may change depending on how the components are mounted and swapped components with different properties. Thus, the alignment ball 2602 may help keep the one or more waveguides 2606 in proper alignment with the projectors in the optical engine 2104. The alignment ball 2602 may be a gimbal bearing. The alignment ball 2602 may be on one or both sides of the optical engine 2604.

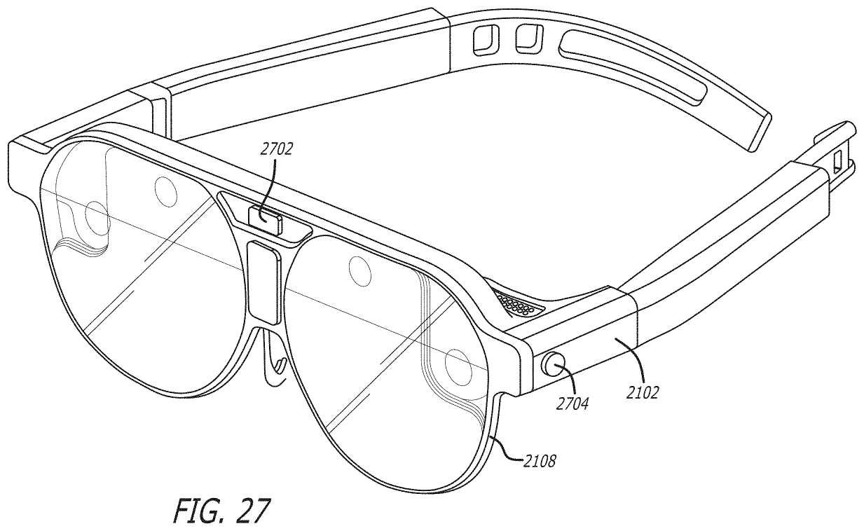

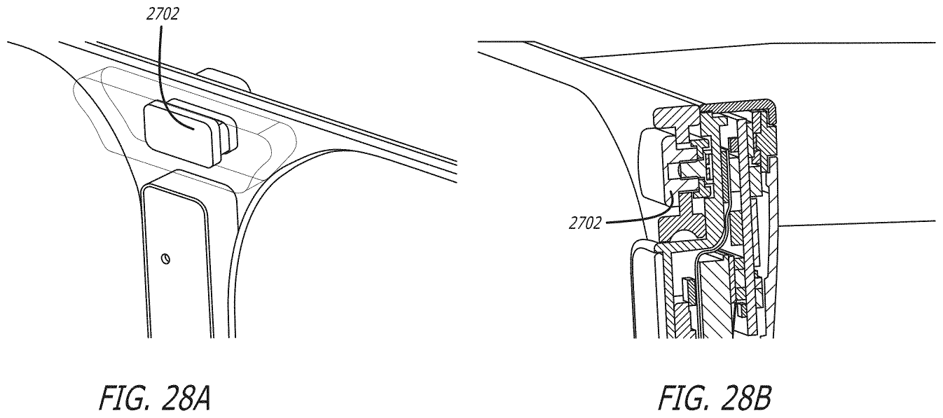

FIG. 27 is a perspective view of the modular waveguide display 2100 without the optical engine 2104 installed and illustrating aspects of the retention mechanism which retains the waveguide frame 2108 on the modular frame 2102. As illustrated, the waveguide frame 2108 may include a slide clip 2702 which may be used to release the center retaining mechanism from the modular frame 2102. The slide clip 2702 may be located in the center of the waveguide frame 2108. FIG. 28A illustrates an enlarged view of the slide clip 2702 and FIG. 28B illustrates a cross-sectional view of the waveguide frame 2108 mounted on the modular frame 2102. The cross-sectional view goes through the slide clip 2702 showing the internal mechanism of the slide clip 2702.

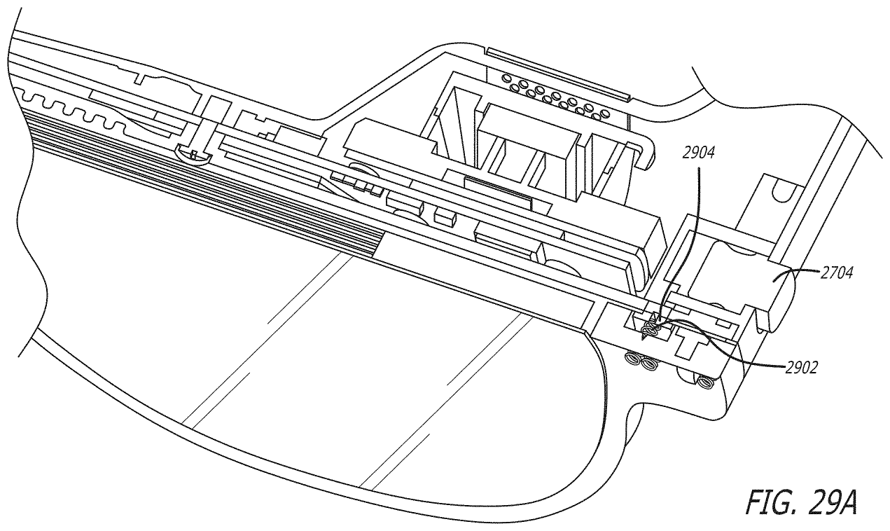

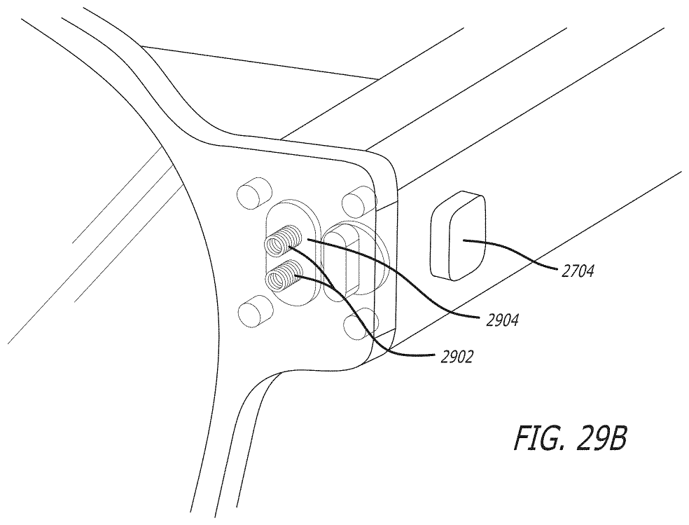

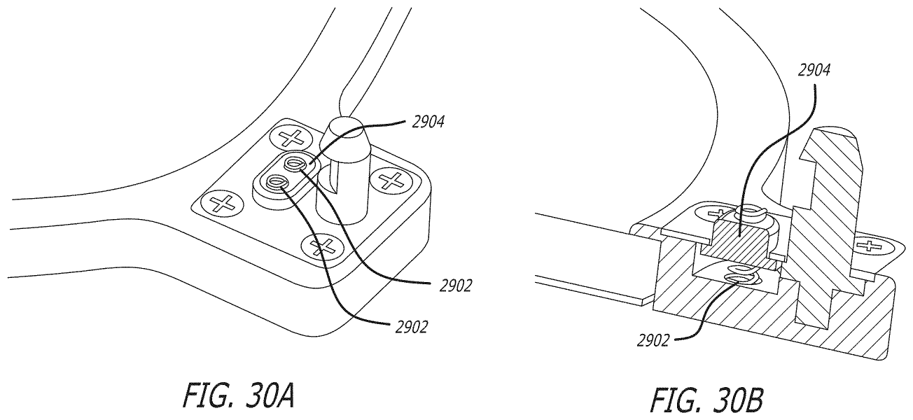

Turning back to FIG. 27, the modular frame 2102 may also include one or more release buttons 2704 which may be used to release one or more connections of the modular frame 2102 to the waveguide frame 2108. FIG. 29A illustrates a cross-sectional view of the waveguide frame 2108 mounted on the modular frame 2102 going through the release button 2704 and showing one or more springs 2902 located on the waveguide frame 2108. The springs 2902 may include a bracket 2904 which may increase the directionality of the movement of the springs 2902. When the release button 2704 is activated, the springs 2902 may work in conjunction with the bracket 2904 to separate the waveguide frame 2108 from the modular frame 2102. FIG. 29B is a view of the waveguide frame 2108 mounted on the modular frame 2102 illustrating the positioning of the springs 2902 and the bracket 2904. FIGS. 30A and 30B are various views of the waveguide frame 2108 illustrating the springs 2902 and the bracket 2904.

As discussed previously, all the additional features discussed in connection with FIGS. 21-30 may be applicable to devices discussed throughout this disclosure. For example, the additional features of FIGS. 21-30 may also be implemented in the devices discussed in connection with FIGS. 1-20.

### Doctrine of Equivalents

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

1. A modular waveguide display device comprising:
a modular frame;
a waveguide lens attached to the modular frame, wherein the waveguide lens is configured to be attached to the modular frame to locate one or more waveguides within the waveguide lens in front of the modular frame; and
an optical engine which is configured to be attached to the modular frame, wherein, when the optical engine is attached to the frame, the optical engine is configured to provide image containing light to a front side of the one or more waveguides.

2. The modular waveguide display device of claim 1, wherein the front side of the one or more waveguides is the side opposite to a user's eye.

3. The modular waveguide display device of claim 1, wherein the one or more waveguides comprise incoupling optical elements and outcoupling optical elements, and wherein, the optical engine is further configured to inject the image containing light into the one or more waveguides through the incoupling optical elements

4. The modular waveguide display device of claim 3, wherein the outcoupling optical elements are configured to output the image containing light into a user's eye.

5. The modular waveguide display device of claim 4, wherein the incoupling optical elements are configured to receive modulated light coming from the same direction as modulated light outputted by the outcoupling optical element.

6. The modular waveguide display device of claim 1, wherein the modular frame comprises at least one of one or more cameras, one or more speakers, one or more microphones, and one or more batteries.

7. The modular waveguide display device of claim 6, wherein the one or more cameras comprises stereo cameras integrated at opposite sides of the modular frame.

8. The modular waveguide display device of claim 7, wherein the stereo cameras are configured to perform tracking.

9. The modular waveguide display device of claim 8, wherein the tracking comprises six degrees of freedom tracking.

10. The modular waveguide display device of claim 6, wherein the one or more cameras comprises a center camera mounted integrated in the center of the modular frame.

11. The modular waveguide display device of claim 1, wherein the modular frame is adapted to accept another optical engine which is attachable to and removable from the waveguide lens, and wherein, when the other optical engine is attached to the waveguide lens, the other optical engine is configured to inject light containing image information into the one or more waveguides.

12. The modular waveguide display device of claim 1, wherein the optical engine is configured to be removable from the modular frame and the modular frame is capable of operating without the optical engine installed.

13. The modular waveguide display device of claim 12, wherein the modular frame is configured to capture images, capture videos, operate as a virtual assistant, record sound, or play sound when the optical engine is removed.

14. The modular waveguide display device of claim 1, wherein the waveguide lens is configured to be removable from the modular frame and the modular frame is capable of operating without the waveguide lens installed.

15. A modular waveguide display device comprising:
a waveguide lens;
an optical engine; and
a modular frame comprising:
a first mechanical connector configured to connect the waveguide lens to the modular frame;
a second mechanical connector configured to connect the optical engine to the modular frame; and
an electrical connector which connects to a corresponding electrical connector on the optical engine allowing the modular frame to operate the optical engine,
wherein, when the waveguide lens and the optical engine are mounted on the modular frame, the optical engine is configured to inject light containing image data into the waveguide lens.

16. (canceled)

17. The modular waveguide display device of claim 15, wherein the modular frame comprises at least one of a mono-camera, a stereo-camera, audio speakers, or a microphone.

18. The modular waveguide display device of claim 17, wherein the modular frame is configured to continue operating the at least one of mono-camera, stereo-camera, audio speakers, or microphone when the optical engine is removed from the modular frame.

19. (canceled)

20. The modular waveguide display device of claim 15, wherein the second mechanical connector and the electrical connector of the modular frame is configured to accept another optical engine.

21. The modular waveguide display device of claim 20, wherein the optical engine and the other optical engine have different features from one another.

22. The modular waveguide display device of claim 15, wherein the first mechanical connector is configured to accept another waveguide lens.

23-40. (canceled)
